(19) United States
(12) Patent Application Publication
(10) Pub. No.: US 2025/0146966 A1
(43) Pub. Date: May 8, 2025

(54) CONDUCTIVE COMPOSITIONS AND RELATED ARTICLES AND METHODS OF SENSING ANALYTES

(71) Applicant: Massachusetts Institute of Technology, Cambridge, MA (US)

(72) Inventors: Aristide Gumyusenge, Cambridge, MA (US); Heejung Roh, Cambridge, MA (US)

(73) Assignee: Massachusetts Institute of Technology, Cambridge, MA (US)

(21) Appl. No.: 18/922,104

(22) Filed: Oct. 21, 2024

Related U.S. Application Data
(60) Provisional application No. 63/592,165, filed on Oct. 21, 2023.

(51) Int. Cl. G01N 27/12; B82Y 15/00; H01B 1/12; H01B 1/22

(52) U.S. Cl. CPC G01N 27/126; H01B 1/128; H01B 1/22; B82Y 15/00

(57) ABSTRACT

Compositions comprising an electronically conductive polymer and a metal-organic framework (MOF), and related sensors and methods of sensing analytes, are generally described.

### RELATED APPLICATIONS

This application claims priority under 35 U.S.C. § 119(e) to U.S. Provisional Patent Application No. 63/592,165, filed Oct. 21, 2023, and entitled “CONDUCTIVE METAL ORGANIC FRAMEWORKS (MOF)-POLYMER HYBRID FILMS AND GAS SENSOR MADE THEREOF,” which is incorporated herein by reference in its entirety for all purposes.

### TECHNICAL FIELD

Compositions comprising an electronically conductive polymer and a metal-organic framework (MOF), and related sensors and methods of sensing analytes, are generally described.

### BACKGROUND

Metal-organic frameworks (MOFs) are attractive for catalysis, energy storage, chemical capture, as well as sensing owing to their inherent porosity, high surface area, and high molecular absorptivity. Particularly for MOF-based sensing, the chemical versatility of metal nodes and organic ligands renders MOFs attractive for molecularly tuning both sensitivity and selectivity towards a wide range of analytes. Pore size control also provides an additional knob for size-exclusion based sensing. Electrically conductive MOFs (cMOFs) are of particular interest in chemiresistive sensors leveraging their conductance modulation within the framework upon host-guest interaction to identify and quantify the guest molecules. However, deploying cMOFs in sensors still faces technological challenges: i) MOFs are commonly synthesized as powders and their integration into electronic devices is challenging. Typically, MOF powders are pressed into pellets or suspended as pastes to form active layers, leading to poor performance reproducibility and loss in inherent properties at the expense of additive loadings. Layer-by-layer liquid epitaxy and surface-supported MOF growth, though yet to be demonstrated for a wide library of MOF structures, have emerged as alternative processing strategies for applications requiring high quality thin films. ii) MOF-based chemical sensors are dosimetric due to limited reversibility which hinders practical implementation limiting them to single-use applications.

Particular to gas sensing, cMOF-based detection of gases typically involves a combination of physical adsorption and chemical interactions. For instance, ligand designs to form electron rich coordination sites favorable for attracting polar gas molecules through van der Waals interactions have been demonstrated. In addition, transition-metal nodes in these cMOFs primarily drive the majority of chemiresistive sensing owing to strong Lewis acid-base reactions between the metal nodes and analytes, especially polar gas molecules. Consequently, 2D-conjugated ligands, namely 2,3,6,7,10,11-hexahydroxytriphenylene (HHTP) and 2,3,6,7,10,11-hexaiminotripphenylene (HITP), in combination with metal nodes (Cu, Ni, Co) have been studied in chemiresistive gas sensors owing to their excellent and tunable electrical conductivity (which enables detection based on resistance change), as well as their facile synthesizability. In that regard, gases such as NH₃, H₂S, and other volatile organic compounds have been reliably detected using cMOF-based sensors.

NO₂ is one of the commonly emitted toxic gases that remains challenging to detect, even using conductive MOFs, especially at room temperature. Though cMOFs have shown promising performance for NO₂ detection, irreversible sensing remains a major challenge due to the formation of stable coordination complexes, a trait that enables high sensitivity. Reversible detection of NO₂ at room temperature using MOFs becomes an inherent challenge due to strong binding behaviors, arising from NO₂'s tendency to extract electrons from metal nodes (e.g., Cu¹⁺) and form coordination complexes (e.g., (1) N-nitro, (2) O-nitrito, or (3) O, O′ bidentate) following the reaction below:

NO_{2(g)}↔NO_{2(ads)}⁻+h⁺

Due to this charge transfer, the cMOF's electron density distribution is perturbed thus translating into detectable resistance changes. To achieve sensor reversibility, approaches such as the use of elevated temperatures, incorporation of noble metal catalysts, photoactivation utilizing specific wavelengths, and incorporation of heavy-metal nanoparticles have been reported to improve recovery kinetics, which still hamper real-world deployments. In fact, these approaches remain the state-of-the-art, despite unique and promising features of cMOFs for NO₂ detection. For real-world use, these approaches remain too costly, challenging to generalize, and user unfriendly, thus calling for innovative strategies to fully leverage the affinity of MOFs towards NO₂ and other analytes. Efforts to expand the library of MOFs used in sensing applications have led to the utilization of polymer/MOFs hybrids when direct film growth of MOFs is challenging. However, this approach often results in a compromise between processability and inherent properties. That is, MOFs are typically blended with polymer additives, which are often insulating polymers, thus masking the intrinsic properties of the MOF components.

Thus, advancements to synergistically marry sensing performance and processability especially for detecting analytes such as NO₂ gas at room temperature are needed.

### SUMMARY

Compositions comprising an electronically conductive polymer and a MOF, and related sensors and methods of sensing analytes, are generally described. This Summary introduces a selection of concepts in simplified form that are described further below in the Detailed Description. This Summary neither identifies key or essential features, nor limits the scope, of the claimed subject matter.

According to certain embodiments, a composition is described, the composition comprising an electronically conductive polymer and a plurality of particles homogenously distributed throughout a bulk of the electronically conductive polymer. In some embodiments, the plurality of particles comprises a conjugated metal-organic framework (MOF). In certain embodiments, the electronically conductive polymer has the formula [A-B]ₙ, wherein A is an electron acceptor monomeric unit, B is an electron donor monomeric unit, and n is greater than or equal to 2.

In some embodiments, a sensor is described, the sensor comprising a first electrode, a second electrode, and a composite region comprising: (i) an electronically conductive polymer; and (ii) an electronically conductive metal-organic framework (MOF). In certain embodiments, the composite region is configured to adsorb an analyte at a temperature greater than or equal to 10° C. and less than or equal to 30° C., wherein adsorption of the analyte within the composite region causes a detectable change in an electronic characteristic of the sensor.

According to some embodiments, a method of sensing an analyte is described, the method comprising exposing a sample suspected of containing the analyte to a sensor comprising an electronically conductive polymer and a metal-organic framework (MOF). In certain embodiments, the exposing is performed at a temperature greater than or equal to 10° C. and less than or equal to 30° C. In some embodiments, the analyte, when present, is configured to interact with the sensor and cause a detectable change in an electronic characteristic of the sensor.

One aspect of the disclosure herein is a hybrid system comprising a conductive polymer (cP) and a conductive metal-organic framework (cMOF).

In some embodiments, the cP comprises an acceptor selected from the group consisting of:

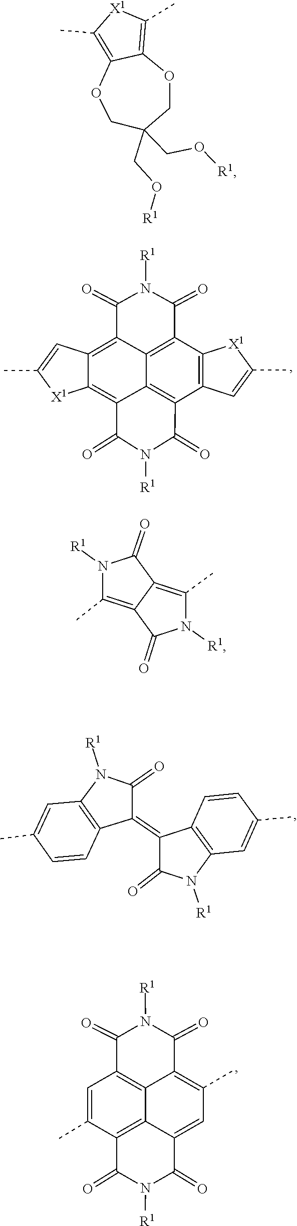

and optionally substituted derivatives thereof,
wherein:
each X¹ group is the same or different and is selected from the group consisting of O, S, Se, Te, and NR¹,
each R¹ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
each dotted line represents: (i) a terminal end of the electronically conductive polymer; or (ii) a bond between an electron acceptor monomeric unit and an electron donor monomeric unit.

In certain embodiments, the cP comprise a donor selected from the group consisting of:

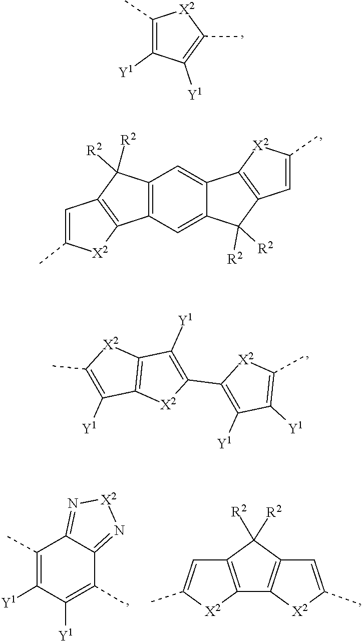

and optionally substituted derivatives thereof,
wherein:
each X² group is the same or different and is selected from the group consisting of O, S, Se, Te, and NR²,
each Y¹ group is the same or different and is selected from the group consisting of H, C₁-C₁₀ alkyl, C₂-C₁₀ alkenyl, C₃-C₁₀ alkynyl, and a halogen,
each R² group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
each dotted line represents: (i) a terminal end of the electronically conductive polymer; or (ii) a bond between an electron acceptor monomeric unit and an electron donor monomeric unit.

According to certain embodiments, the cMOF comprises a metal node selected from Cu, Ni, Co, and Fe.

In some embodiments, the cMOF comprises a conjugated ligand selected from the group consisting of:

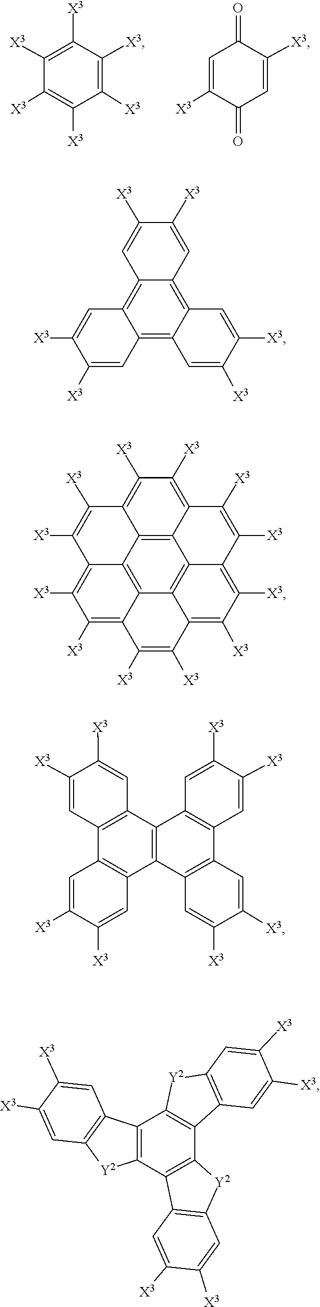

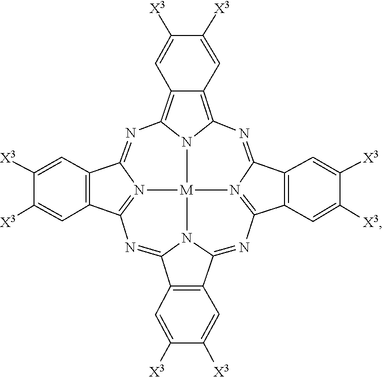

and optionally substituted derivatives thereof,
wherein:
each X³ group is the same or different and is selected from the group consisting of O, S, Se, Te, and NR³,
each Y² group is the same or different and is selected from the group consisting of C, NR³, O, S, Se, and Te,
each R³ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
M is a transition metal ion.

In one embodiment of the hybrid system, the cMOF comprises conjugated ligands connected by four, six, eight, or more metal nodes.

In one embodiment of the hybrid system, the cMOF forms a pore with a diameter of at least 1 nm.

One aspect of the disclosure herein is a formulation comprising a hybrid film consisting essentially of the cP and the cMOF of the disclosed hybrid system.

In one embodiment, the formulation comprises a ratio of cP:cMOF between 1 and 100 wt % cMOF.

One aspect of the disclosure herein is a gas sensor comprising the disclosed hybrid film.

In one embodiment, the gas sensor preferably detects a gas selected from NO₂, H₂S, ethanol, methanol, acetone, toluene, xylene, and ammonia.

In one embodiment, the gas sensor preferably detects NO₂.

The following Detailed Description references the accompanying drawings which form a part this application, and which show, by way of illustration, specific example implementations. Other implementations may be made without departing from the scope of the disclosure.

Other advantages and novel features of the present disclosure will become apparent from the following Detailed Description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 shows a schematic cross-sectional diagram of a composition in the form of a layer and/or film, in accordance with certain embodiments.

FIG. 2 shows a top-view schematic diagram of a sensor, in accordance with certain embodiments.

FIG. 3A shows a chemical structure and a representative scanning electron microscopy (SEM) image of a two-dimensional (2D) cMOF (M₃(ligand)₂), in accordance with certain embodiments.

FIG. 3B shows a chemical structure and a representative SEM image of a cP, in accordance with certain embodiments.

FIG. 3C shows schematic diagrams of irreversible chemiresistive behavior constructed from a pristine cMOF, in accordance with certain embodiments.

FIG. 3D shows: (i) schematic diagrams of a sensing device and an interaction between cP@cMOF and a gas analyte (top), and reversible and sensitive chemiresistive behavior enabled by hybridization with favorable energy band alignment (middle); and (ii) a representative SEM image of a cP@cMOF (bottom), in accordance with certain embodiments.

FIG. 3E shows powder X-ray diffraction (PXRD) spectra of a 2D cMOF, a cP, and a corresponding cP@cMOF, in accordance with certain embodiments.

FIG. 4A shows response graphs of pristine cMOFs, in accordance with certain embodiments.

FIG. 4B shows response graphs of cP@cMOFs, in accordance with certain embodiments.

FIG. 4C shows response graphs of sensors including pristine cMOFs, cP@ligands, and cP@cMOFs (N≥3), in accordance with certain embodiments.

FIG. 4D shows response graphs of Co₃(HHTP)₂ and cP@Co₃(HHTP)₂ toward 2.5-0.25 ppm NO₂ gas, in accordance with certain embodiments.

FIG. 4E shows response graphs of Ni₃(HITP)₂ and cP@Ni₃(HITP)₂ toward 2.5-0.25 ppm NO₂ gas, in accordance with certain embodiments.

FIG. 4F shows response graphs of Co₃(HHTP)₂, Ni₃(HITP)₂, cP@Co₃(HHTP)₂, and cP@Ni₃(HITP)₂ toward 2.5-0.25 ppm NO₂ gas (N≥3), in accordance with certain embodiments.

FIG. 4G shows response graphs of cP@cMOFs and conventional NO₂ sensors using cP or cMOFs, operating at room temperature, in accordance with certain embodiments.

FIG. 4H shows the operational stability of a cP@Co₃(HHTP)₂ sensor under 97 cyclic exposures (1 ppm NO₂, 5 min exposure, 10 min air recovery), in accordance with certain embodiments.

FIG. 4I shows an enlargement of FIG. 4H around t=605-760 min, in accordance with certain embodiments.

FIG. 5A shows an experimentally constructed energy level diagram of a cP and a cMOF and a proposed mechanism for enhanced recovery upon hybrid, in accordance with certain embodiments.

FIG. 5B shows high resolution X-ray photoelectron spectra (XPS) of a Cu 2p peak region, before (top) and after (bottom) NO₂ exposure, in accordance with certain embodiments.

FIGS. 5C-5D show high resolution XPS spectra of a N 1s peak region of Cu₃(HHTP)₂ and cP@Cu₃(HHTP)₂, respectively, before (top) and after (bottom) NO₂ exposure, in accordance with certain embodiments.

FIG. 6A shows a chemical structure of a n-type polymer, in accordance with certain embodiments.

FIG. 6B shows dynamic resistance transitions with varied types of polymers in hybrid, in accordance with certain embodiments.

FIG. 6C shows response profiles with varied types of polymers in hybrid, in accordance with certain embodiments.

FIG. 6D shows differences in charge density before and after NO₂ binding to a cMOF cluster for three system conditions: hole-excess, charge-neutral, and electron-excess, calculated as ρ (Cluster+NO₂)−ρ (Cluster)−ρ (NO₂), where ρ is the charge density, in accordance with certain embodiments.

FIG. 6E shows binding energies of a cMOF and NO₂ when the cMOF has an excess hole (top) and an excess electron (bottom), compared to a charge-neutral cMOF, in accordance with certain embodiments.

FIGS. 7A-7B show UV-vis spectra of a p-type cP and a n-type cP, respectively, in accordance with certain embodiments.

FIGS. 8A-8F show X-ray diffraction (XRD) analysis of Co₃(HHTP)₂, Cu₃(HHTP)₂, Ni₃(HHTP)₂, Co₃(HITP)₂, Cu₃(HITP)₂, and Ni₃(HITP)₂, respectively, in accordance with certain embodiments.

FIGS. 9A-9B show SEM images of a representative pristine p-type cP and a cMOF (Cu₃(HHTP)₂), respectively, in accordance with certain embodiments.

FIGS. 9C-9E show atomic force microscopy (AFM) images of a cP, a cMOF, and a cP@cMOF, respectively, in accordance with certain embodiments.

FIGS. 10A-10C show XPS high-resolution spectra of pristine cMOFs and cP@cMOF hybrids using Cu₃(HHTP)₂-based cMOFs, Ni₃(HHTP)₂-based cMOFs, and Ni₃(HITP)₂-based cMOFs, respectively, in accordance with certain embodiments.

FIGS. 11A-11C show Raman spectroscopy of pristine cMOFs, in accordance with certain embodiments.

FIG. 11D shows Raman spectroscopy of a pristine cP, in accordance with certain embodiments.

FIGS. 11E-11G show Raman spectroscopy of hybrid cP@cMOFs, in accordance with certain embodiments.

FIG. 12A shows a schematic illustration of a gas sensing measurement system, in accordance with certain embodiments.

FIGS. 12B-12C show optical images of a sensor chip and a sensor electrode, respectively, in accordance with certain embodiments.

FIGS. 13A-13B show resistance transitions of pristine cMOFs toward 2.5 ppm NO₂ gas and cP@cMOFs toward 2.5 ppm NO₂ gas, respectively, in accordance with certain embodiments.

FIG. 14A shows dynamic resistance transitions of cP@HHTP and cP@HITP, in accordance with certain embodiments.

FIG. 14B shows response graphs of cP@HHTP and cP@HITP upon exposure to NO₂ gas (N=3), in accordance with certain embodiments.

FIGS. 15A-15C show dynamic resistance transitions of cP@MWCNT 1:1 w/w % upon exposure to 2.5-0.25 ppm NO₂ gas, cP@SWCNT 9:1 w/w % upon exposure to 2.5-0.25 ppm NO₂ gas, and cP@SWCNT 20:1 w/w % upon exposure to 2.5-0.25 ppm NO₂ gas, respectively, in accordance with certain embodiments.

FIG. 15D shows a response graph of cP@SWCNTs upon exposure to 2.5-0.25 ppm NO₂ gas (N=3), in accordance with certain embodiments.

FIGS. 16A-16F show dynamic resistance transitions of pristine cMOFs and cP@cMOFs toward 2.5 ppm NO₂ gas for Co₃(HHTP)₂-based sensors with various ratios between cP and cMOFs, Cu₃(HHTP)₂-based sensors with various ratios between cP and cMOFs, Ni₃(HHTP)₂-based sensors with various ratios between cP and cMOFs, Co₃(HITP)₂-based sensors with various ratios between cP and cMOFs, Cu₃(HITP)₂-based sensors with various ratios between cP and cMOFs, and Ni₃(HITP)₂-based sensors with various ratios between cP and cMOFs, respectively, in accordance with certain embodiments.

FIGS. 17A-17F show response graphs of pristine cMOFs and cP@cMOFs for Co₃(HHTP)₂-based sensors with various ratios between cP and cMOFs (N≥3), Cu₃(HHTP)₂-based sensors with various ratios between cP and cMOFs (N≥3), Ni₃(HHTP)₂-based sensors with various ratios between cP and cMOFs (N≥3), Co₃(HITP)₂-based sensors with various ratios between cP and cMOFs (N≥3), Cu₃(HITP)₂-based sensors with various ratios between cP and cMOFs (N≥3), and Ni₃(HITP)₂-based sensors with various ratios between cP and cMOFs (N≥3), respectively, in accordance with certain embodiments.

FIGS. 18A-18F show dynamic resistance transitions of pristine cMOFs and cP@cMOFs toward 2.5-0.25 ppm NO₂ gas for Co₃(HHTP)₂-based sensors with various ratios between cP and cMOFs, Cu₃(HHTP)₂-based sensors with various ratios between cP and cMOFs, Ni₃(HHTP)₂-based sensors with various ratios between cP and cMOFs, Co₃(HITP)₂-based sensors with various ratios between cP and cMOFs, Cu₃(HITP)₂-based sensors with various ratios between cP and cMOFs, and Ni₃(HITP)₂-based sensors with various ratios between cP and cMOFs, respectively, in accordance with certain embodiments.

FIGS. 19A-19F show response graphs of pristine cMOFs and cP@cMOFs toward 2.5-0.25 ppm NO₂ gas for Co₃(HHTP)₂-based sensors with various ratios between cP and cMOFs (N≥3), Cu₃(HHTP)₂-based sensors with various ratios between cP and cMOFs (N≥3), Ni₃(HHTP)₂-based sensors with various ratios between cP and cMOFs (N≥3), Co₃(HITP)₂-based sensors with various ratios between cP and cMOFs (N≥3), Cu₃(HITP)₂-based sensors with various ratios between cP and cMOFs (N≥3), and Ni₃(HITP)₂-based sensors with various ratios between cP and cMOFs (N≥3), respectively, in accordance with certain embodiments.

FIGS. 20A-20C show cyclic sensing tests of Ni₃(HHTP)₂-based sensors with various ratios between cP and cMOFs, Cu₃(HHTP)₂-based sensors with various ratios between cP and cMOFs, and Cu₃(HITP)₂-based sensors with various ratios between cP and cMOFs, respectively, in accordance with certain embodiments.

FIGS. 21A-21C show response and recovery fitting curves and raw response and recovery curves of cP@Co₃(HHTP)₂ 1:1_1 μl, cP@Co₃(HHTP)₂ 1:1_3 μl, and cP@Co₃(HHTP)₂ 1:1_5 μl sensors, respectively, in accordance with certain embodiments.

FIG. 21D shows adsorption and desorption rate constants of three different sensors, in accordance with certain embodiments.

FIGS. 22A-22F show selectivity of Cu₃(HHTP)₂, cP@Cu₃(HHTP)₂ 1:8, cP@Cu₃(HHTP)₂ 1:4, cP@Cu₃(HHTP)₂ 1:1, cP@Cu₃(HHTP)₂ 4:1, and cP@Cu₃(HHTP)₂ 8:1, respectively, in accordance with certain embodiments.

FIG. 22G shows overall response graphs (N≥3), in accordance with certain embodiments.

FIGS. 23A-23F show selectivity of Ni₃(HHTP)₂, cP@Ni₃(HHTP)₂ 1:8, cP@Ni₃(HHTP)₂ 1:4, cP@Ni₃(HHTP)₂ 1:1, cP@Ni₃(HHTP)₂ 4:1, cP@Ni₃(HHTP)₂ 8:1, respectively, in accordance with certain embodiments.

FIG. 23G shows overall response graphs (N≥3), in accordance with certain embodiments.

FIG. 24A shows dynamic resistance transitions, in accordance with certain embodiments.

FIG. 24B shows response graphs of cP@Co₃(HHTP)₂ prepared by three different methods; i) finely mixed cP@Co₃(HHTP)₂, ii) Co₃(HHTP)₂ overlayer on cP, and iii) cP overlayer on Co₃(HHTP)₂ (N=3), in accordance with certain embodiments.

FIGS. 25A-25G show XPS cutoff curves (left), Fermi curves (middle), and Tauc plots (right), respectively, of cMOFs and cP for p-type cP and Cu₃(HHTP)₂, n-type cP, Co₃(HHTP)₂, Ni₃(HHTP)₂, Cu₃(HITP)₂, and Co₃(HITP)₂, and Ni₃(HITP)₂, respectively, in accordance with certain embodiments.

FIG. 26 shows energy levels of cP and cMOFs described herein, in accordance with certain embodiments.

FIG. 27 shows HOMO and LUMO levels of cMOFs both with and without a hole, as well as with and without an adsorbate, in accordance with certain embodiments.

FIG. 28 shows distribution of binding energies for NO₂, NH₃, and H₂S to different sites on a monomer of a cP, as indicated by arrows, in accordance with certain embodiments.

FIGS. 29A-29B show response and recovery fitting curves of cMOFs and cP@cMOF 1:1 composites, respectively, in accordance with certain embodiments.

FIGS. 29C-29D shows adsorption rate constants and desorption rate constants, respectively, in accordance with certain embodiments.

FIG. 30A shows XRD analysis of Cu₃(HHTP)₂ with high and low crystallinity, in accordance with certain embodiments.

FIG. 30B shows NO₂ sensing response of cP@Cu₃(HHTP)₂ and pristine Cu₃(HHTP)₂ using high and low crystallinity of cMOFs (N≥3), in accordance with certain embodiments.

FIG. 30C shows XRD analysis of Co₃(HHTP)₂ with high and low crystallinity, in accordance with certain embodiments.

FIG. 30D shows NO₂ sensing response of cP@Co₃(HHTP)₂ with high and low crystallinity (N≥3), in accordance with certain embodiments.

FIG. 31A shows dynamic resistance transitions of p-type cP@Cu₃(HHTP)₂ 1:1 and n-type cP@Cu₃(HHTP)₂ 1:1 upon sequential exposure to 2.5 ppm and 12.5 ppm NO₂ gas, in accordance with certain embodiments.

FIG. 31B shows response graphs of p-type cP@Cu₃(HHTP)₂ 1:1 and n-type cP@Cu₃(HHTP)₂ 1:1 upon sequential exposure to 2.5 ppm and 12.5 ppm NO₂ gas, in accordance with certain embodiments.

FIGS. 32A-32B show top view schematic diagrams of complete cMOF structures for M₃(HHTP)₂ and M₃(HITP)₂, respectively, in accordance with certain embodiments.

FIGS. 32C-32E show clusters of M₃(HHTP)₂ for various oxidation states of the metal, +0, +1, and +2, respectively, in accordance with certain embodiments.

FIGS. 32F-32I show clusters of M₃(HHTP)₂ while binding with H₂S, clusters of M₃(HHTP)₂ while binding with NH₃, clusters of M₃(HHTP)₂ while binding with NO₂ with nitrogen atom binding, and clusters of M₃(HHTP)₂ while binding with NO₂ with oxygen atom binding, respectively, in accordance with certain embodiments.

FIG. 33 shows binding energy of H₂S and NH₃ to a MOF compared with that of NO₂, in accordance with certain embodiments.

FIG. 34 shows a comparison of results to conventional NO₂ sensing at room temperature using cPs- and cMOFs-based chemiresistors, in accordance with certain embodiments.

FIG. 35 shows a summary of experimentally measured energy level details, in accordance with certain embodiments.

### DETAILED DESCRIPTION

Compositions comprising an electronically conductive polymer and a MOF, and related sensors and methods of sensing analytes, are generally described. According to some embodiments, the electronically conductive polymer comprises a conjugated system. The electronically conductive polymer may be a copolymer having the formula [A-B]ₙ, wherein A is an electron acceptor monomeric unit, B is an electron donor monomeric unit, and n is greater than or equal to 2. In certain embodiments, the MOF is an electronically conductive MOF comprising a plurality of metal ions coordinated to at least one conjugated ligand. In accordance with certain embodiments, employing an electronically conductive polymer and an electronically conductive MOF advantageously promotes efficient charge transport throughout a bulk of the composition. In certain embodiments, the electronically conductive polymer and MOF-containing composition enhances the overall sensitivity of the composition towards one or more analytes as compared to: (i) conventional compositions that are otherwise equivalent but do not comprise the electronically conductive polymer; and/or (ii) conventional compositions that are otherwise equivalent but do not comprise the MOF.

In certain embodiments, a sensor (e.g., chemiresistor) described herein comprises a composite region disposed between two electrodes, the composite region comprising an electronically conductive polymer and a MOF. The composite region may be configured to selectively adsorb an analyte (e.g., from a mixture of components), thereby causing a detectable change in an electronic characteristic of the sensor, such as a change in resistance of the sensor. Adsorption of the analyte may advantageously occur at room temperature (e.g., greater than or equal to 15° C. and less than or equal to 25° C.), although higher and lower adsorption temperatures are also possible. The composite region may be further configured to desorb the analyte at room temperature. Advantageously, the stable and reversible adsorption and desorption of an analyte overcomes deficiencies in conventional chemiresistors that use elevated temperatures, incorporation of catalysts and/or heavy metal-containing nanoparticles, and/or photoactivation to achieve reversible cycling.

Methods of sensing an analyte described herein comprise exposing a sample suspected of containing the analyte to a sensor (e.g., at room temperature). In some embodiments, the analyte, when present, is configured to interact with a portion of the sensor and cause a detectable change in an electronic characteristic of the sensor, such as a change in resistance of the sensor. For example, in some embodiments, the method comprises adsorbing the analyte within a composite region of the sensor and detecting the detectable change in the electronic characteristic of the sensor. The method may further comprise desorbing the analyte from the composite region of the sensor. Cycling the sensor by adsorbing the analyte within the composite region and desorbing the analyte from the composite region may occur greater than 95 times, thereby providing long-term stability and reliable analyte sensing, even at at room temperature.

According to certain embodiments, the composition comprises an electronically conductive polymer. In some embodiments, the electronically conductive polymer is or comprises a conjugated system. The term “conjugated system” is used herein in a manner consistent with its ordinary meaning in the art. A conjugated system is a system of connected p-orbitals with delocalized electrons in a molecule with alternating single and double bonds.

In some embodiments, the electronically conductive polymer is a p-type electronically conductive polymer. As used herein, the term “p-type electronically conductive polymer” refers to a polymer in which an electron is removed from one or more orbitals of the polymer, thereby providing a positive charge (or hole). According to certain embodiments, the electronically conductive polymer is not a n-type electronically conductive polymer. As used herein, the term “n-type electronically conductive polymer” refers to a polymer in which electrons are the majority charge carriers.

In some embodiments, the electronically conductive polymer is an electronically conductive copolymer. The term “copolymer” is used herein in a manner consistent with its ordinary meaning in the art. A copolymer is a polymer derived from more than one species of monomer. In certain embodiments, for example, the electronically conductive polymer (e.g., copolymer) has the formula [A-B]ₙ, wherein A is a first monomeric unit, B is a second monomeric unit, and n is greater than or equal to 2.

The value of n in the formula [A-B]ₙ may be any of a variety of suitable values. In some embodiments, for example, n is greater than or equal to 2, greater than or equal to 5, greater than or equal to 10, greater than or equal to 20, greater than or equal to 50, greater than or equal to 100, greater than or equal to 200, greater than or equal to 500, greater than or equal to 1000, greater than or equal to 2000, greater than or equal to 5000, or greater. In certain embodiments, n is less than or equal to 10000, less than or equal to 5000, less than or equal to 2000, less than or equal to 1000, less than or equal to 500, less than or equal to 200, less than or equal to 100, less than or equal to 50, less than or equal to 20, less than or equal to 10, or less than or equal to 5. Combinations of the above recited ranges are possible (e.g., n is greater than or equal to 2 and less than or equal to 10000, n is greater than or equal to 100 and less than or equal to 200). Other ranges are also possible.

According to certain embodiment, A in the formula [A-B]ₙ is an electron acceptor monomeric unit. As used herein, the term “electron acceptor” refers to a chemical entity that readily accepts electrons transferred to it from another chemical entity.

The electron acceptor monomeric unit may have any of a variety of suitable structures. In some embodiments, for example, the electron acceptor monomeric unit is selected from the group consisting of:

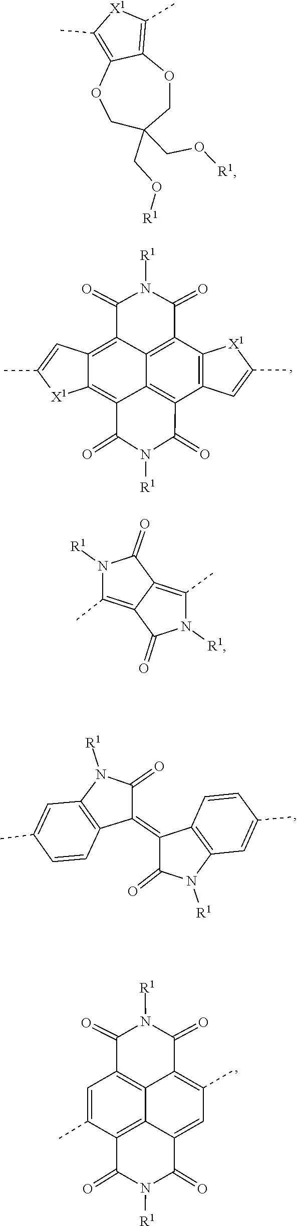

and optionally substituted derivatives thereof,
wherein:
each X¹ group is the same or different and is selected from the group consisting of O, S, Se, Te, and NR¹,
each R¹ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
each dotted line represents: (i) a terminal end of the electronically conductive polymer; or (ii) a bond between the electron acceptor monomeric unit and an electron donor monomeric unit.

In some embodiments wherein a R¹ group is an ether of C₁-C₁₀ alkyl, C₂-C₁₀ alkenyl, or C₃-C₁₀ alkynyl, R¹ may be R^{1′}—O—R^{1′}, wherein R^{1′} is selected from the group consisting of C₁-C₁₀ alkyl, C₂-C₁₀ alkenyl, C₃-C₁₀ alkynyl, and optionally substituted derivatives thereof.

In some embodiments wherein a R¹ group is a halogenated derivative of C₁-C₁₀ alkyl, C₂-C₁₀ alkenyl, or C₃-C₁₀ alkynyl, R¹ may be R^{1′}—X, wherein R^{1′} is selected from the group consisting of C₁-C₁₀ alkyl, C₂-C₁₀ alkenyl, C₃-C₁₀ alkynyl, and optionally substituted derivatives thereof, and X is a halogen (e.g., fluorine (F), chlorine (Cl), bromine (Br), and/or iodine (I)).

According to certain embodiments wherein a dotted line represents a terminal end of the electronically conductive polymer, the dotted line may represent a bond to one or more polar groups that terminally end the electronically conductive polymer. The one or more polar groups may advantageously facilitate adsorption of an analyte within the composition, as described elsewhere in greater detail.

In some embodiments, B in the formula [A-B]ₙ is an electron donor monomeric unit. As used herein, the term “electron donor” refers to a chemical entity that is able to transfer electrons to another chemical entity.

The electron donor monomeric unit may have any of a variety of suitable structures. In some embodiments, for example, the electron donor monomeric unit is selected from the group consisting of:

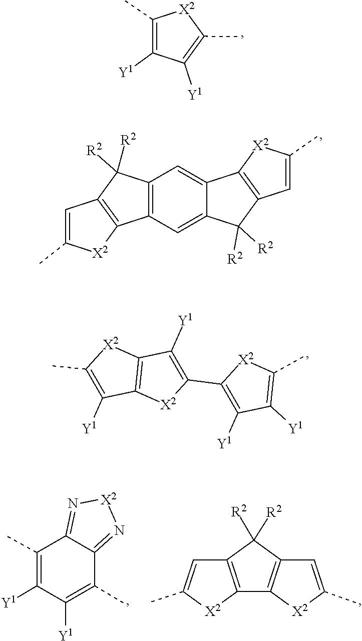

and optionally substituted derivatives thereof,
wherein:
each X² group is the same or different and is selected from the group consisting of O, S, Se, Te, and NR²,
each Y¹ group is the same or different and is selected from the group consisting of H, C₁-C₁₀ alkyl, C₂-C₁₀ alkenyl, C₃-C₁₀ alkynyl, and a halogen (e.g., fluorine (F), chlorine (Cl), bromine (Br), and/or iodine (I)),
each R² group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and each dotted line represents: (i) a terminal end of the electronically conductive polymer; or (ii) a bond between the electron acceptor monomeric unit and the electron donor monomeric unit.

In some embodiments wherein a R² group is an ether of C₁-C₁₀ alkyl, C₂-C₁₀ alkenyl, or C₃-C₁₀ alkynyl, R² may be R^{2′}—O—R^{2′}, wherein R^{2′} is selected from the group consisting of C₁-C₁₀ alkyl, C₂-C₁₀ alkenyl, C₃-C₁₀ alkynyl, and optionally substituted derivatives thereof.

In some embodiments wherein a R² group is a halogenated derivative of C₁-C₁₀ alkyl, C₂-C₁₀ alkenyl, or C₃-C₁₀ alkynyl, R² may be R^{2′}—X, wherein R^{2′} is selected from the group consisting of C₁-C₁₀ alkyl, C₂-C₁₀ alkenyl, C₃-C₁₀ alkynyl, and optionally substituted derivatives thereof, and X is a halogen (e.g., fluorine (F), chlorine (Cl), bromine (Br), and/or iodine (I)).

According to certain embodiments wherein a dotted line represents a terminal end of the electronically conductive polymer, the dotted line may represent a bond to one or more polar groups that terminally end the electronically conductive polymer. The one or more polar groups may advantageously facilitate adsorption of an analyte within the composition, as described elsewhere in greater detail.

The electronically conductive polymer may be synthesized via any of a variety of suitable methods. In some embodiments, the electronically conductive polymer is synthesized via a coupling reaction between a first monomeric precursor and a second monomeric precursor. The first monomeric precursor and the second monomeric precursor may be purchased commercially and/or synthesized according to techniques known to a person of ordinary skill in the art. In certain embodiments, for example, a solution is prepared by dissolving and/or suspending a first monomeric precursor and a second monomeric precursor in one or more solvents (e.g., water and/or an organic solvent). In some embodiments, a catalyst (e.g., a palladium-based catalyst) is added to the solution. In certain embodiments, the solution is heated to facilitate a coupling reaction between the first monomeric precursor and the second monomeric precursor. In some embodiments, a product is precipitated from the solution, which is then filtered and/or purified to provide the electronically conductive polymer.

In some embodiments, the composition comprises a metal-organic framework (MOF). The terms “metal-organic framework” and “MOF” are used herein in a manner consistent with their ordinary meaning in the art. A MOF is a class of porous polymers consisting of metal nodes coordinated to ligands to form one-, two-, or three-dimensional structures.

In certain embodiments, the MOF is electronically conductive. According to some embodiments, the MOF is or comprises a conjugated system. In certain embodiments, for example, the MOF comprises at least one ligand that is or is part of a conjugated system.

In certain embodiments, the MOF comprises a plurality of metal ions. The plurality of metal ions may comprise any of a variety of suitable metal ions. In some embodiments, for example, the plurality of metal ions comprises one or more transition metal ions. In certain embodiments, the plurality of metal ions comprises copper (Cu) ions, nickel (Ni) ions, cobalt (Co) ions, iron (Fe) ions, zinc (Zn) ions, palladium (Pd) ions, and/or combinations thereof. Other metal ions are also possible.

According to certain embodiments, at least one metal ion of the plurality of metal ions is coordinated to at least one ligand (e.g., conjugated ligand). In some embodiments, each metal ion of the plurality of metal ions is coordinated to at least one ligand (e.g., conjugated ligand).

The ligand (e.g., conjugated ligand) may be any of a variety of suitable ligands. In certain embodiments, the ligand comprises an optionally substituted benzene moiety, an optionally substituted benzoquinone moiety, an optionally substituted triphenylene moiety, an optionally substituted coronene moiety, an optionally substituted dibenzo[g,p]chrysene moiety, an optionally substituted truxene moiety, an optionally substituted phthalocyanine moiety, and/or combinations thereof. In certain embodiments, the ligand comprises a hexahydroxytriphenylene (HTTP) moiety and/or a hexaiminotripphenylene (HITP) moiety.

In some embodiments, the ligand (e.g., conjugated ligand) is selected from the group consisting of:

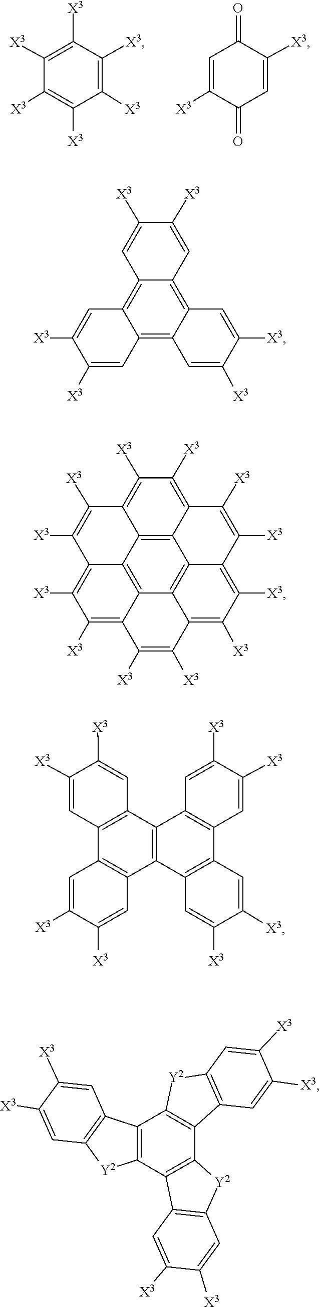

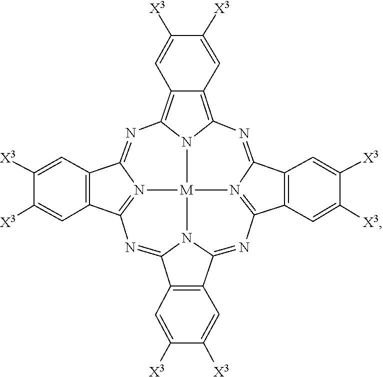

and optionally substituted derivatives thereof,
wherein:
each X³ group is the same or different and is selected from the group consisting of O, S, Se, Te, and NR³,
each Y² group is the same or different and is selected from the group consisting of C, NR³, O, S, Se, and Te,
each R³ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and M is a metal ion.

In some embodiments wherein a R³ group is an ether of C₁-C₁₀ alkyl, C₂-C₁₀ alkenyl, or C₃-C₁₀ alkynyl, R³ may be R^{3′}—O—R^{3′}, wherein R^{3′} is selected from the group consisting of C₁-C₁₀ alkyl, C₂-C₁₀ alkenyl, C₃-C₁₀ alkynyl, and optionally substituted derivatives thereof.

In some embodiments wherein a R³ group is a halogenated derivative of C₁-C₁₀ alkyl, C₂-C₁₀ alkenyl, or C₃-C₁₀ alkynyl, R³ may be R^{3′}—X, wherein R^{3′} is selected from the group consisting of C₁-C₁₀ alkyl, C₂-C₁₀ alkenyl, C₃-C₁₀ alkynyl, and optionally substituted derivatives thereof, and X is a halogen (e.g., fluorine (F), chlorine (Cl), bromine (Br), and/or iodine (I)).

The M metal ion may be any of a variety of suitable metal ions. In some embodiments, for example, M is a transition metal ion. Suitable transition metal ions include, but are not limited to, Cu ions, Ni ions, Co ions, Fe ions, Zn ions, Pd ions, and/or combinations thereof. Other metal ions are also possible.

According to certain embodiments, at least one metal ion of the plurality of metal ions is coordinated to at least one ligand (e.g., conjugated ligand) via at least one X³ group. In some embodiments, each metal ion of the plurality of metal ions is coordinated to at least one ligand (e.g., conjugated ligand) via at least one X³ group. The coordination between the metal ion and the ligand (e.g., conjugated ligand) via at least one X³ group may be a bonding interaction between the metal ion and the at least one X³ group. In some embodiments, for example, the bonding interaction between the metal ion and the at least one X³ group is a covalent bonding interaction.

In some embodiments, the MOF comprises a plurality of pores. The plurality of pores may have any of a variety of suitable dimensions. In certain embodiments, for example, each pore of the plurality of pores has a maximum characteristic dimension of at least 1 nm, at least 1.5 nm, at least 2 nm, at least 2.5 nm, at least 3 nm, or at least 4 nm. In some embodiments, each pore of the plurality of pores has a maximum characteristic dimension of less than or equal to 5 nm, less than or equal to 4 nm, less than or equal to 3 nm, less than or equal to 2.5 nm, less than or equal to 2 nm, or less than or equal to 1.5 nm. Combinations of the above recited ranges are possible (e.g., each pore of the plurality of pores has a maximum characteristic dimension of at least 1 nm and less than or equal to 5 nm, each pore of the plurality of pores has a maximum characteristic dimension of at least 1.5 nm and less than or equal to 2.5 nm). Other ranges are also possible. According to some embodiments, the maximum characteristic dimension of a pore may be determined by electron microscopy techniques such as transmission electron microscopy (TEM).

The MOF may be synthesized via any of a variety of suitable methods. In certain embodiments, for example, a first solution of a metal ion salt is prepared by dissolving and/or suspending the metal ion salt in one or more solvents (e.g., water and/or an organic solvent). In some embodiments, a second solution of a ligand (e.g., conjugated ligand) is prepared by dissolving and/or suspending the ligand in one or more solvents (e.g., water and/or an organic solvent). In certain embodiments, the first solution and the second solution are mixed to provide a third solution comprising the metal ion salt and the ligand (e.g., conjugated ligand). In some embodiments, the third solution is heated to facilitate a reaction between the metal ion salt and the ligand (e.g., conjugated ligand). In some embodiments, a product is precipitated from the third solution, which is then filtered and/or purified to provide the MOF.

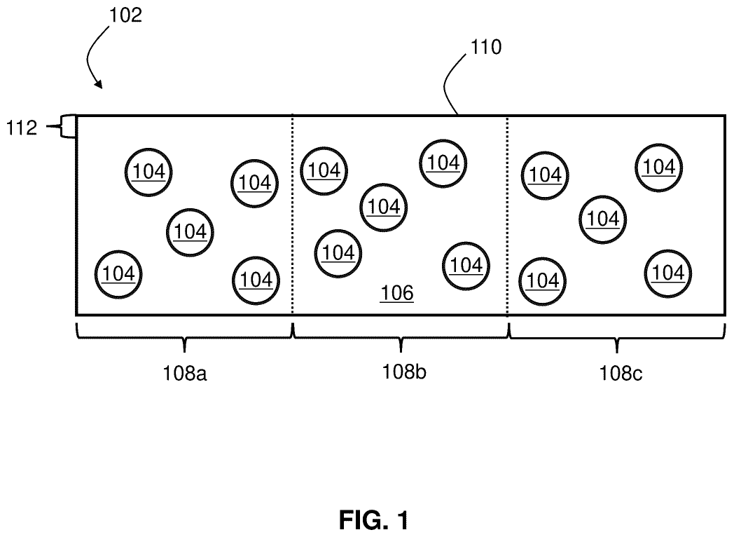

The composition may have any of a variety of suitable configurations. In some embodiments, for example, the composition is in the form of a layer and/or film. FIG. 1 shows a schematic cross-sectional diagram of composition 102 in the form of a layer and/or film, in accordance with certain embodiments. In certain embodiments, the composition in the form of a layer and/or film is semicrystalline.

In some embodiments, the composition in the form of a layer and/or film is ionically conductive and/or electronically conductive. According to some embodiments, a composition comprising an electronically conductive (e.g., conjugated) polymer and an electronically conductive (e.g., conjugated) MOF advantageously promotes efficient charge transport throughout a bulk of the composition. In certain embodiments, a composition comprising a p-type electronically conductive (e.g., conjugated) polymer and an electronically conductive (e.g., conjugated) MOF advantageously promotes efficient transfer of holes from the p-type electronically conductive (e.g., conjugated) polymer to the electronically conductive (e.g., conjugated) MOF, thereby enhancing the ability of the composition to interact with (e.g., adsorb) an analyte, as described elsewhere herein in greater detail.

According to some embodiments, the composition comprises a plurality of particles comprising the MOF. Referring, for example, the FIG. 1, composition 102 comprises plurality of particles 104 comprising the MOF.

In certain embodiments, the plurality of particles comprises a plurality of nanoparticles. The term “nanoparticle” is used herein in a manner consistent with its ordinary meaning in the art. A nanoparticle is a particle having a maximum characteristic dimension from 1 nanometer to 1 micrometer. The maximum characteristic dimension of a particle generally refers to the longest dimension from a first surface of the particle to a second surface of the particle that is substantially opposite the first surface. According to some embodiments, the maximum characteristic dimension of the nanoparticle is from 1 nanometer to 100 nanometers, 100 nanometers to 200 nanometers, 200 nanometers to 300 nanometers, 300 nanometers to 500 nanometers, 500 nanometers to 700 nanometers, or 700 nanometers to 1 micrometer. Combinations of the above recited ranges are possible (e.g., 300 nanometers to 700 nanometers, or 200 nanometers to 1 micrometer). Other ranges are also possible. The maximum characteristic dimension of the nanoparticle may be determined by electron microscopy techniques (e.g., scanning electron microscopy).

In some embodiments, the plurality of particles comprises a plurality of microparticles. The term “microparticle” is used herein in a manner consistent with its ordinary meaning in the art. A microparticle is a particle having a maximum characteristic dimension (e.g., a maximum diameter) from 1 micrometer to 100 micrometers. According to some embodiments, the maximum characteristic dimension of the microparticle is from 1 micrometer to 10 micrometers, 10 micrometers to 20 micrometers, 20 micrometers to 30 micrometers, 30 micrometers to 50 micrometers, 50 micrometers to 70 micrometers, or 70 micrometers to 100 micrometers. Combinations of the above recited ranges are possible (e.g., 30 micrometers to 70 micrometers, or 20 micrometers to 100 micrometers). Other ranges are also possible. The maximum characteristic dimension of the microparticle may be determined by electron microscopy techniques (e.g., scanning electron microscopy).

According to some embodiments, the plurality of particles is homogeneously distributed throughout a bulk of the electronically conductive polymer. Referring, for example, to FIG. 1, plurality of particles 104 is homogenously distributed throughout a bulk of electronically conductive polymer 106. In some embodiments, for example, the amount of particles does not vary by more than 50%, by more than 40%, by more than 30%, by more than 20%, by more than 10%, by more than 5%, or by more than 1% in any given first arbitrary subsection of composition 102 (e.g., subsection 108a, subsection 108b, subsection 108c) as compared to any given second arbitrary subsection of composition 102 that is different than the first arbitrary subsection. In certain embodiments, the first arbitrary subsection of the composition and the second arbitrary subsection of the composition each comprise at least 10%, at least 20%, at least 30%, at least 40%, or at least 50% of a cross-section of the composition taken across any axis of the composition. The homogeneous distribution of the plurality of particles throughout the bulk of the electronically conductive polymer may be determined by AFM.

According to some embodiments, the electronically conductive polymer and the MOF interact with each other. In certain embodiments, for example, the electronically conductive polymer and the MOF interact with each other via one or more bonding interactions. Suitable bonding interactions include, but are not limited to, non-covalent bonding interactions such as electrostatic interactions, π-interactions (e.g., π-π stacking between one or more aromatic portions of the electronically conductive polymer and one or more aromatic portions of the MOF), van der Waals forces, and/or combinations thereof.

According to certain embodiments, the composition in the form of a layer and/or film comprises a surface. Referring, for example, to FIG. 1, composition 102 in the form of a layer and/or film comprises surface 110. The surface of the composition in the form of a layer and/or film may have any of a variety of suitable root mean square roughness (Rq) values. In some embodiments, for example, the surface of the composition in the form of a layer and/or film has a Rq value less than or equal to 100 nm, less than or equal to 95 nm, less than or equal to 90 nm, less than or equal to 80 nm, less than or equal to 70 nm, less than or equal to 60 nm, less than or equal to 50 nm, less than or equal to 40 nm, or less than or equal to 30 nm. In certain embodiments, the surface of the composition in the form of a layer and/or film has a Rq value greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, greater than or equal to 90 nm, or greater than or equal to 95 nm. Combinations of the above recited ranges are possible (e.g., the composition in the form of a layer and/or film has a Rq value less than or equal to 100 nm and greater than or equal to 20 nm, the composition in the form of a layer and/or film has a Rq value less than or equal to 80 nm and greater than or equal to 70 nm). Other ranges are also possible. The Rq value of the surface of the composition in the form of a layer and/or film may be determined by AFM.

In certain embodiments, the composition in the form of a layer and/or film comprises no or substantially no particles of the plurality of particles within a certain depth of the composition measured from a surface of the layer and/or film. Referring, for example, to FIG. 1, composition 102 in the form of a layer and/or film comprises no or substantially no particles 104 of the plurality of particles within depth 112 of composition 102 measured from surface 110 of the layer and/or film. The depth may be any of a variety of suitable values. In certain embodiments, for example, the depth is at least 1 nm, at least 2 nm, at least 5 nm, at least 10 nm, at least 20 nm, at least 50 nm, at least 100 nm, at least 200 nm, or at least 500 nm. In some embodiments, the depth is less than or equal to 1000 nm, less than or equal to 500 nm, less than or equal to 200 nm, less than or equal to 100 nm, less than or equal to 50 nm, less than or equal to 20 nm, less than or equal to 10 nm, less than or equal to 5 nm, or less than or equal to 2 nm. Combinations of the above recited ranges are possible (e.g., the depth is at least 1 nm and less than or equal 1000 nm, the depth is at least 20 nm and less than or equal to 50 nm). Other ranges are also possible. The amount of particles within a depth of the composition in the form of a layer and/or film as measured from a surface of the layer and/or film may be determined by XPS and Raman spectroscopy.

The composition may comprise the electronically conductive polymer in any of a variety of suitable amounts. In some embodiments, for example, the composition comprises the electronically conductive polymer in an amount greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % versus a total weight of the composition. In certain embodiments, the composition comprises the electronically conductive polymer in an amount less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, or less than or equal to 30 wt % versus a total weight of the composition. Combinations of the above recited ranges are possible (e.g., the composition comprises the electronically conductive polymer in an amount greater than or equal to 25 wt % and less than or equal to 95 wt % versus a total weight of the composition, the composition comprises the electronically conductive polymer in an amount greater than or equal to 60 wt % and less than or equal to 65 wt % versus a total weight of the composition). Other ranges are also possible.

The composition may comprise the plurality of particles in any of a variety of suitable amounts. In some embodiments, for example, the composition comprises the plurality of particles in an amount greater than or equal to 5 weight percent (wt %), greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, or greater than or equal to 70 wt % versus a total weight of the composition. In certain embodiments, the composition comprises the plurality of particles in an amount less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % versus a total weight of the composition. Combinations of the above recited ranges are possible (e.g., the composition comprises the plurality of particles in an amount greater than or equal to 5 wt % and less than or equal to 75 wt % versus a total weight of the composition, the composition comprises the plurality of particles in an amount greater than or equal to 40 wt % and less than or equal to 45 wt % versus a total weight of the composition). Other ranges are also possible.

The composition may be synthesized via any of a variety of suitable methods. In some embodiments, for example, a first solution of the electronically conductive polymer is prepared by dissolving and/or suspending the electronically conductive polymer in one or more solvents (e.g., water and/or an organic solvent). In certain embodiments, a second solution of the plurality of particles comprising the MOF is prepared by dissolving and/or suspending the plurality of particles comprising the MOF in one or more solvents (e.g., water and/or an organic solvent). In some embodiments, the first solution and the second solution are mixed to provide a third solution comprising the electronically conductive polymer and the plurality of particles comprising the MOF. In certain embodiments, the third solution is cast onto a substrate and dried, thereby providing the composition disposed on a substrate.

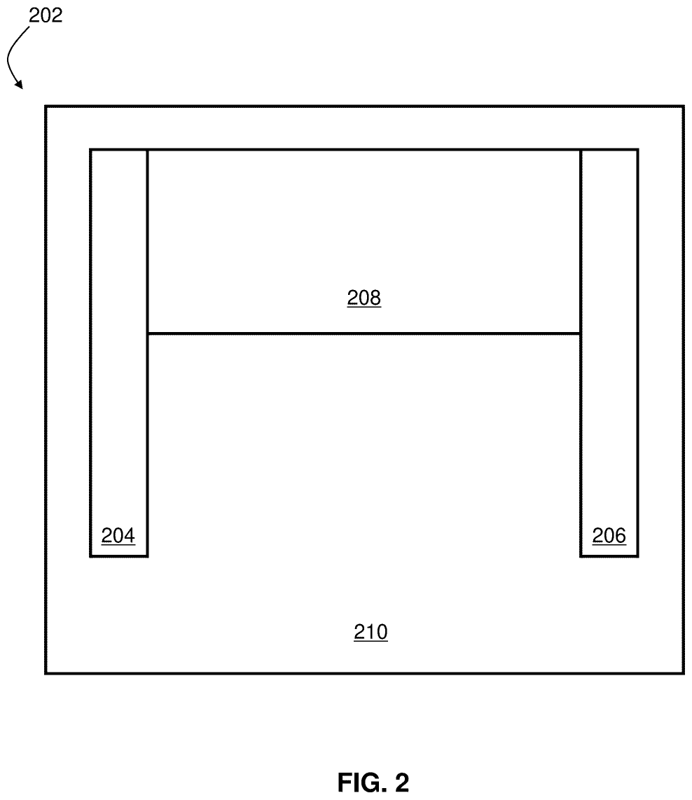

According to certain embodiments, a sensor is described. FIG. 2 shows a top-view schematic diagram of sensor 202, in accordance with certain embodiments.

In some embodiments, the sensor comprises a first electrode and a second electrode. Referring, for example, to FIG. 2, sensor 202 comprises first electrode 204 and second electrode 206.

The first electrode and/or the second electrode may comprise any of a variety of suitable materials. In some embodiments, for example, the first electrode and/or the second electrode comprise a metal. Suitable metals include, but are not limited to, gold (Au). Other metals are also possible.

According to certain embodiments, the sensor comprises a composite region. For example, referring to FIG. 2, sensor 202 comprises composite region 208. In some embodiments, composite region 208 may be the same as composition 102 shown in FIG. 1. In some embodiments, for example, the composite region comprises an electronically conductive polymer and a MOF, each of which are described elsewhere herein in greater detail.

According to some embodiments, the composite region is disposed between the first electrode and the second electrode. For example, referring to FIG. 2, composite region 208 is disposed between first electrode 204 and second electrode 206.

In certain embodiments, the first electrode, the second electrode, and the composite region are disposed on a substrate. Referring, for example, to FIG. 2, first electrode 204, second electrode, 206, and composite region 208 are disposed on substrate 210.

The substrate may comprise any of a variety of suitable materials. In some embodiments, for example, the substrate comprises a metal oxide, glass, silicon, a polymer and/or plastic, and/or combinations thereof. In certain non-limiting embodiments, the substrate comprises Al₂O₃. Other materials are also possible.

Although not shown in the figures, the sensor may comprise one or more connections (e.g., electronic connections) to one or more external components, such as a data acquisition system.

According to some embodiments, the composite region is configured to adsorb an analyte. The analyte may be or comprise any of a variety of suitable analytes. In certain embodiments, for example, the analyte is or comprises a gas, a liquid, a solid, and/or combinations thereof. In some embodiments, the analyte is or comprises NO₂, H₂S, ethanol, methanol, acetone, toluene, xylene, ammonia, and/or combinations thereof. Other analytes are also possible.

The composite region may be configured to adsorb the analyte at any of a variety of suitable temperatures. According to certain embodiments, the adsorption temperature (or desorption temperature, as described herein in greater detail) may refer to a temperature of an environment of the composition (or component of the sensor, such as the composite region). As used herein, the term “temperature of an environment” of the composition (or component of the sensor) refers to the temperature of a substantially stagnant environment surrounding the composition (or component of the sensor). In certain non-limiting embodiments, for example, the composition (or component of the sensor) is surrounded by substantially stagnant air, and the temperature of the environment of the composition (or component of the sensor) refers to the temperature of the substantially stagnant air surrounding the composition (or component of the sensor). According to certain embodiments, the temperature of the environment of the composition (or component of the sensor) is the temperature of the surrounding substantially stagnant environment (e.g., air) measured (e.g., using a thermometer or temperature sensor) at a distance less than or equal to 15 centimeters from an external surface of the composition (or component of the sensor). In certain embodiments, the temperature of the environment of the composition (or component of the sensor) is measured at a point at which heat equilibrium between the temperature of the environment of the composition (or component of the sensor) and the external surface of the composition (or component of the sensor) is reached. For example, in some embodiments, the temperature of the environment of the composition (or component of the sensor) is measured after the composition (or component of the sensor) is placed in the temperature of the environment of the composition (or component of the sensor) for at least 1 hour, at least 2 hours, at least 4 hours, at least 6 hours, at least 8 hours, or more.

According to some embodiments, the composite region is configured to adsorb the analyte at room temperature (e.g., greater than or equal to 15° C. and less than or equal to 25° C.). The composite region may, in some embodiments, be configured to adsorb the analyte at temperatures lower than room temperature (e.g., less than or equal to 15° C., less than or equal to 10° C., less than or equal to 5° C., less than or equal to 1° C., or less) and/or higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater), as the disclosure is not meant to be limiting in this regard.

In some embodiments, the composite region is configured to adsorb an analyte at a temperature greater than or equal to 10° C., greater than or equal to 15° C., greater than or equal to 20° C., or greater than or equal to 25° C. In certain embodiments, the composite region is configured to adsorb an analyte at a temperature less than or equal to 30° C., less than or equal to 25° C., less than or equal to 20° C., or less than or equal to 15° C. Combinations of the above recited ranges are possible (e.g., the composite region is configured to adsorb an analyte at a temperature greater than or equal to 10° C. and less than or equal to 30° C., the composite region is configured to adsorb an analyte at a temperature greater than or equal to 15° C. and less than or equal to 25° C.). Other ranges are also possible.

According to some embodiments, adsorption of the analyte within the composite region causes a detectable change in an electronic characteristic of the sensor. In certain embodiments, for example, the detectable change in the electronic characteristic of the sensor is a change in resistance of the sensor. Other detectable changes in the electronic characteristic of the sensor are also possible.

In certain embodiments, the composite region is configured to desorb the analyte. The composite region may be configured to desorb the analyte at any of a variety of suitable temperatures. According to some embodiments, for example, the composite region is configured to desorb the analyte at room temperature (e.g., greater than or equal to 15° C. and less than or equal to 25° C.). The composite region may, in some embodiments, be configured to desorb the analyte at temperatures lower than room temperature (e.g., less than or equal to 15° C., less than or equal to 10° C., less than or equal to 5° C., less than or equal to 1° C., or less) and/or higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater), as the disclosure is not meant to be limiting in this regard.

In some embodiments, the composite region is configured to desorb an analyte at a temperature greater than or equal to 10° C., greater than or equal to 15° C., greater than or equal to 20° C., or greater than or equal to 25° C. In certain embodiments, the composite region is configured to desorb an analyte at a temperature less than or equal to 30° C., less than or equal to 25° C., less than or equal to 20° C., or less than or equal to 15° C. Combinations of the above recited ranges are possible (e.g., the composite region is configured to desorb an analyte at a temperature greater than or equal to 10° C. and less than or equal to 30° C., the composite region is configured to desorb an analyte at a temperature greater than or equal to 15° C. and less than or equal to 25° C.). Other ranges are also possible.

The composite region may be configured to adsorb the analyte and desorb the analyte any of a variety of suitable number of times. In some embodiments, for example, the composite region is configured to adsorb the analyte and desorb the analyte at least 1 time, at least 2 times, at least 5 times, at least 10 times, at least 20 times, at least 30 times, at least 40 times, at least 50 times, at least 60 times, at least 70 times, at least 80 times, at least 90 times, at least 95 times, at least 100 times, at least 200 times, at least 300 times, or at least 400 times. In certain embodiments, the composite region is configured to adsorb the analyte and desorb the analyte less than or equal to 500 times, less than or equal to 400 times, less than or equal to 300 times, less than or equal to 200 times, less than or equal to 100 times, less than or equal to 95 times, less than or equal to 90 times, less than or equal to 80 times, less than or equal to 70 times, less than or equal to 60 times, less than or equal to 50 times, less than or equal to 40 times, less than or equal to 30 times, less than or equal to 20 times, less than or equal to 10 times, less than or equal to 5 times, or less than or equal to 2 times. Combinations of the above recited ranges are possible (e.g., the composite region is configured to adsorb the analyte and desorb the analyte at least 1 time and less than or equal to 500 times, the composite region is configured to adsorb the analyte and desorb the analyte at least 95 times and less than or equal to 100 times). Other ranges are also possible.

The sensor may be fabricated by any of a variety of suitable methods. In certain embodiments, for example, the first electrode and the second electrode are deposited onto a substrate. In some embodiments, a solution comprising the electronically conductive polymer and the plurality of particles comprising the MOF is cast onto the substrate in a region between the first electrode and the second electrode. Suitable casting method include, but are not limited to, spin-coating, blade-coating, and/or screen-printing. In certain embodiments, the cast solution comprising the electronically conductive polymer and the plurality of particles comprising the MOF is dried, thereby providing the sensor.

According to certain embodiments, a method of sensing an analyte is described. In some embodiments, the method comprises exposing a sample suspected of containing an analyte to a sensor. In certain embodiments, the sensor comprises an electronically conductive polymer and a MOF. For example, in some embodiments, the sensor comprises a composite region comprising the electronically conductive polymer and the MOF, as described elsewhere herein in greater detail.

The exposing may be performed at any of a variety of suitable temperatures (e.g., any of a variety of suitable temperatures of an environment of the sensor). In certain embodiments, for example, the exposing is performed at room temperature (e.g., greater than or equal to 15° C. and less than or equal to 25° C.). The exposing may, in some embodiments, be performed at temperatures lower than room temperature (e.g., less than or equal to 15° C., less than or equal to 10° C., less than or equal to 5° C., less than or equal to 1° C., or less) and/or higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater), as the disclosure is not meant to be limiting in this regard.

In certain embodiments, the exposing is performed at a temperature greater than or equal to 10° C., greater than or equal to 15° C., greater than or equal to 20° C., or greater than or equal to 25° C. In some embodiments, the exposing is performed at a temperature less than or equal to 30° C., less than or equal to 25° C., less than or equal to 20° C., or less than or equal to 15° C. Combinations of the above recited ranges are possible (e.g., the exposing is performed at a temperature greater than or equal to 10° C. and less than or equal to 30° C., the exposing is performed at a temperature greater than or equal to 15° C. and less than or equal to 25° C.). Other ranges are also possible.

The sample suspected of containing an analyte may be or comprise any of a variety of suitable components. In certain embodiments, for example, the sample is or comprises one or more gases, one or more liquids, one or more solids, and/or combinations thereof. In some embodiments wherein the sample contains the analyte, the sample may be or comprise a mixture of gases comprising a gaseous analyte. In certain embodiments wherein the sample contains the analyte, the sample may be or comprise a mixture of liquids comprising a liquid analyte. In some embodiments wherein the sample contains the analyte, the sample may be or comprise a mixture of solids comprising a solid analyte.

The analyte may be or comprise any of a variety of suitable analytes as described elsewhere herein in greater detail. In some embodiments, for example, the analyte is or comprises a gas, a liquid, a solid, and/or combinations thereof. Suitable analytes include, but are not limited to, NO₂, H₂S, ethanol, methanol, acetone, toluene, xylene, ammonia, and/or combinations thereof. Other analytes are also possible.

According to certain embodiments, the analyte, when present, is configured to interact with the sensor. For example, in some embodiments, the analyte, when present, is configured to interact with one or more components of the composite region. In certain embodiments, the analyte, when present, is configured to interact with the electronically conductive polymer. In some embodiments, the analyte, when present, is configured to interact with the MOF. According to some embodiments, the analyte, when present, is configured to interact with the electronically conductive polymer and the MOF.

In some embodiments, the method comprises adsorbing the analyte within the composite region. The adsorbing may be performed at any of a variety of suitable temperatures (e.g., any of a variety of suitable temperatures of an environment of the sensor). In certain embodiments, for example, the adsorbing is performed at room temperature (e.g., greater than or equal to 15° C. and less than or equal to 25° C.). The adsorbing may, in some embodiments, be performed at temperatures lower than room temperature (e.g., less than or equal to 15° C., less than or equal to 10° C., less than or equal to 5° C., less than or equal to 1° C., or less) and/or higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater), as the disclosure is not meant to be limiting in this regard.

In some embodiments, the adsorbing is performed at a temperature greater than or equal to 10° C., greater than or equal to 15° C., greater than or equal to 20° C., or greater than or equal to 25° C. In some embodiments, the adsorbing is performed at a temperature less than or equal to 30° C., less than or equal to 25° C., less than or equal to 20° C., or less than or equal to 15° C. Combinations of the above recited ranges are possible (e.g., the adsorbing is performed at a temperature greater than or equal to 10° C. and less than or equal to 30° C., the adsorbing is performed at a temperature greater than or equal to 15° C. and less than or equal to 25° C.). Other ranges are also possible.

In some embodiments, the analyte, when present, is configured to cause a detectable change in an electronic characteristic of the sensor. In some embodiments, as described elsewhere herein in greater detail, the detectable change in the electronic characteristic of the sensor is a change in resistance of the sensor. Other detectable changes in the electronic characteristic of the sensor are also possible.

In some embodiments, the method comprises detecting the detectable change in the electronic characteristic of the sensor. In certain embodiments, for example, the method comprises detecting a change in resistance of the sensor. The detectable change in the electronic characteristic of the sensor may be performed using a data acquisition system.

The sensor may have any of a variety of suitable limits of detection of the analyte. In certain embodiments, for example, the sensor has a limit of detection of the analyte less than or equal to 100 ppm, less than or equal to 50 ppm, less than or equal to 20 ppm, less than or equal to 10 ppm, less than or equal to 5 ppm, less than or equal to 2 ppm, less than or equal to 1 ppm, less than or equal to 0.5 ppm, or less than or equal to 0.25 ppm. In some embodiments, the sensor has a limit of detection of the analyte greater than or equal to 0.1 ppm, greater than or equal to 0.25 ppm, greater than or equal to 0.5 ppm, greater than or equal to 1 ppm, greater than or equal to 2 ppm, greater than or equal to 5 ppm, greater than or equal to 10 ppm, greater than or equal to 20 ppm, or greater than or equal to 50 ppm. Combinations of the above recited ranges are possible (e.g., the sensor has a limit of detection of the analyte less than or equal to 100 ppm and greater than or equal to 0.1 ppm, the sensor has a limit of detection of the analyte less than or equal to 5 ppm and greater than or equal to 2 ppm). Other ranges are also possible.

According to some embodiments, the method comprises desorbing the analyte from the composite region. The desorbing may be performed at any of a variety of suitable temperatures (e.g., any of a variety of suitable temperatures of an environment of the sensor). In certain embodiments, for example, the desorbing is performed at room temperature (e.g., greater than or equal to 15° C. and less than or equal to 25° C.). The desorbing may, in some embodiments, be performed at temperatures lower than room temperature (e.g., less than or equal to 15° C., less than or equal to 10° C., less than or equal to 5° C., less than or equal to 1° C., or less) and/or higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater), as the disclosure is not meant to be limiting in this regard.

In certain embodiments, the desorbing is performed at a temperature greater than or equal to 10° C., greater than or equal to 15° C., greater than or equal to 20° C., or greater than or equal to 25° C. In some embodiments, the desorbing is performed at a temperature less than or equal to 30° C., less than or equal to 25° C., less than or equal to 20° C., or less than or equal to 15° C. Combinations of the above recited ranges are possible (e.g., the desorbing is performed at a temperature greater than or equal to 10° C. and less than or equal to 30° C., the desorbing is performed at a temperature greater than or equal to 15° C. and less than or equal to 25° C.). Other ranges are also possible.

In certain embodiments, the method comprises adsorbing the analyte within the composite region and desorbing the analyte from the composite region any of a variety of suitable number of times. For example, in some embodiments, the method comprises adsorbing the analyte within the composite region and desorbing the analyte from the composite region at least 1 time, at least 2 times, at least 5 times, at least 10 times, at least 20 times, at least 30 times, at least 40 times, at least 50 times, at least 60 times, at least 70 times, at least 80 times, at least 90 times, at least 95 times, at least 100 times, at least 200 times, at least 300 times, or at least 400 times. In certain embodiments, the method comprises adsorbing the analyte within the composite region and desorbing the analyte from the composite region less than or equal to 500 times, less than or equal to 400 times, less than or equal to 300 times, less than or equal to 200 times, less than or equal to 100 times, less than or equal to 95 times, less than or equal to 90 times, less than or equal to 80 times, less than or equal to 70 times, less than or equal to 60 times, less than or equal to 50 times, less than or equal to 40 times, less than or equal to 30 times, less than or equal to 20 times, less than or equal to 10 times, or less than or equal to 5 times. Combinations of the above recited ranges are possible (e.g., the method comprises adsorbing the analyte within the composite region and desorbing the analyte from the composite region at least 1 time and less than or equal to 500 times, the method comprises adsorbing the analyte within the composite region and desorbing the analyte from the composite region at least 95 times and less than or equal to 100 times). Other ranges are also possible.

In certain embodiments, the method comprises adsorbing the analyte within the composite region and desorbing the analyte from the composite region any of a variety of suitable number of times at any of a variety of suitable temperatures (e.g., any of a variety of suitable temperatures of an environment of the sensor). In some embodiments, for example, the method comprises adsorbing the analyte within the composite region and desorbing the analyte from the composite region at room temperature (e.g., greater than or equal to 15° C. and less than or equal to 25° C.), at temperatures lower than room temperature (e.g., less than or equal to 15° C., less than or equal to 10° C., less than or equal to 5° C., less than or equal to 1° C., or less), and/or at temperatures higher than room temperature (e.g., greater than or equal to 30° C., greater than or equal to 40° C., greater than or equal to 50° C., greater than or equal to 60° C., greater than or equal to 70° C., greater than or equal to 80° C., greater than or equal to 90° C., or greater).

The following application is incorporated herein by reference, in its entirety, for all purposes: U.S. Provisional Patent Application No. 63/592,165, filed Oct. 21, 2023, and entitled “CONDUCTIVE METAL ORGANIC FRAMEWORKS (MOF)-POLYMER HYBRID FILMS AND GAS SENSOR MADE THEREOF”.

Definitions of specific functional groups and chemical terms are described in more detail below. For purposes of this description, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

It will be appreciated that the compounds, as described herein, may be substituted with any number of substituents or functional moieties. In general, the term “substituted” whether preceded by the term “optionally” or not, and substituents contained in formulas described herein, refer to the replacement of hydrogen radicals in a given structure with the radical of a specified substituent (e.g., a substituent which upon substitution results in a stable compound, such as a compound which does not spontaneously undergo transformation such as by rearrangement, cyclization, elimination, or other reaction). When more than one position in any given structure may be substituted with more than one substituent selected from a specified group, the substituent may be either the same or different at every position. As used herein, the term “substituted” is contemplated to include all permissible substituents of organic compounds, and includes any of the substituents described herein that results in the formation of a stable compounds. In a broad aspect, the permissible substituents include acyclic and cyclic, branched and unbranched, carbocyclic and heterocyclic, aromatic and nonaromatic substituents of organic compounds. For purposes of this description, heteroatoms such as nitrogen may have hydrogen substituents and/or any permissible substituents of organic compounds described herein which satisfy the valencies of the heteroatoms and results in the formation of a stable moiety. Furthermore, this description is not intended to be limited in any manner by the permissible substituents of organic compounds. Combinations of substituents and variables envisioned by this description are preferably those that result in the formation of stable compounds. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

As used herein, “alkyl” refers to a radical of a straight-chain or branched saturated hydrocarbon group having from 1 to 10 carbon atoms (“C₁-C₁₀ alkyl”). In some embodiments, an alkyl group has 1 to 9 carbon atoms (“C₁-C₉ alkyl”). In some embodiments, an alkyl group has 1 to 8 carbon atoms (“C₁-C₈ alkyl”). In some embodiments, an alkyl group has 1 to 7 carbon atoms (“C₁-C₇ alkyl”). In some embodiments, an alkyl group has 1 to 6 carbon atoms (“C₁-C₆ alkyl”). In some embodiments, an alkyl group has 1 to 5 carbon atoms (“C₁-C₅ alkyl”). In some embodiments, an alkyl group has 1 to 4 carbon atoms (“C₁-C₄ alkyl”). In some embodiments, an alkyl group has 1 to 3 carbon atoms (“C₁-C₃ alkyl”). In some embodiments, an alkyl group has 1 to 2 carbon atoms (“C₁-C₂ alkyl”). In some embodiments, an alkyl group has 1 carbon atom (“C₁ alkyl”). In some embodiments, an alkyl group has 2 to 6 carbon atoms (“C₂-C₆ alkyl”). Examples of C₁-C₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents. In certain embodiments, the alkyl group is an unsubstituted C₁-C₁₀ alkyl (e.g., —CH₃). In certain embodiments, the alkyl group is a substituted C₁-C₁₀ alkyl.

As used herein, the term “alkenyl” includes a radical of a straight-chain or branched saturated hydrocarbon group having from 2 to 10 carbon atoms, and also includes at least one carbon-carbon double bond. It will be understood that in certain embodiments, alkenyl may be advantageously of limited length, including C₂-C₁₀, C₂-C₉, C₂-C₈, C₂-C₇, C₂-C₆, C₂-C₅, C₂-C₄, and C₂-C₃.

As used herein, the term “alkynyl” includes a radical of a straight-chain or branched saturated hydrocarbon group having from 3 to 10 carbon atoms, and also includes at least one carbon-carbon triple bond. It will be understood that in certain embodiments, alkenyl may be advantageously of limited length, including C₃-C₁₀, C₃-C₉, C₃-C₈, C₃-C₇, C₃-C₆, C₃-C₅, and C₃-C₄.

As used herein, the term “heteroalkyl” refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

As used herein, the term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

As used herein, the term “heteroaryl” refers to aryl groups comprising at least one heteroatom as a ring atom. Suitable heteroatoms include oxygen, sulfur, nitrogen, phosphorus, and the like.

It should be understood that affixing the suffix “-ene” to a group indicates the group is a divalent moiety. For example, alkylene is the divalent moiety of alkyl (e.g., an acyclic carbon or a saturated acyclic carbon chain represented by the formula —CₙH₂ₙ—), alkenylene is the divalent moiety of alkenyl (e.g., an acyclic carbon chain which contains a carbon-to-carbon double bond represented by the formula —CₙH₂ₙ₋₂—), and alkynylene is the divalent moiety of alkynyl (e.g., an acyclic carbon chain which contains a carbon-to-carbon triple bond represented by the formula —CₙH₂ₙ₋₄—). Affixing the suffice “-yne” to a group indicates the group is trivalent moiety (e.g., alkylyne is the trivalent moiety of alkyl, alkenylyne is the trivalent moiety of alkenyl, and alkynylyne is the trivalent moiety of alkynyl).

As used herein, the term “halogen” refers to fluorine (fluoro, —F), chlorine (chloro, —Cl), bromine (bromo, —Br), or iodine (iodo, —I).

The following examples are intended to illustrate certain embodiments of the present disclosure, but do not exemplify the full scope of the disclosure.

### Example

As described herein, hybrid films were formed using designer conjugated polymers and conductive MOFs to improve: (i) The sensitivity compared to pristine cMOFs, stemming from increased density of the active material in the sensor. (ii) Chemical selectivity via the incorporation of systematically functionalized cPs with selective and labile binding with NO₂. (iii) Improved gas accessibility throughout the bulk owing to inherent semicrystalline and open structure of polymer engulfing cMOFs. (iv) Regeneration of active sites within the sensing material, and consequently, long-term reliability or the retention of response at room temperature due to improved permeability towards gas molecules which enhances the kinetics of molecular exchange and a thermodynamically enhanced desorption process. And lastly, (v) solution processability via facile deployment methods (e.g., spin-coating, blade-coating, screen-printing, etc.), which is not readily unattainable in pristine MOFs.

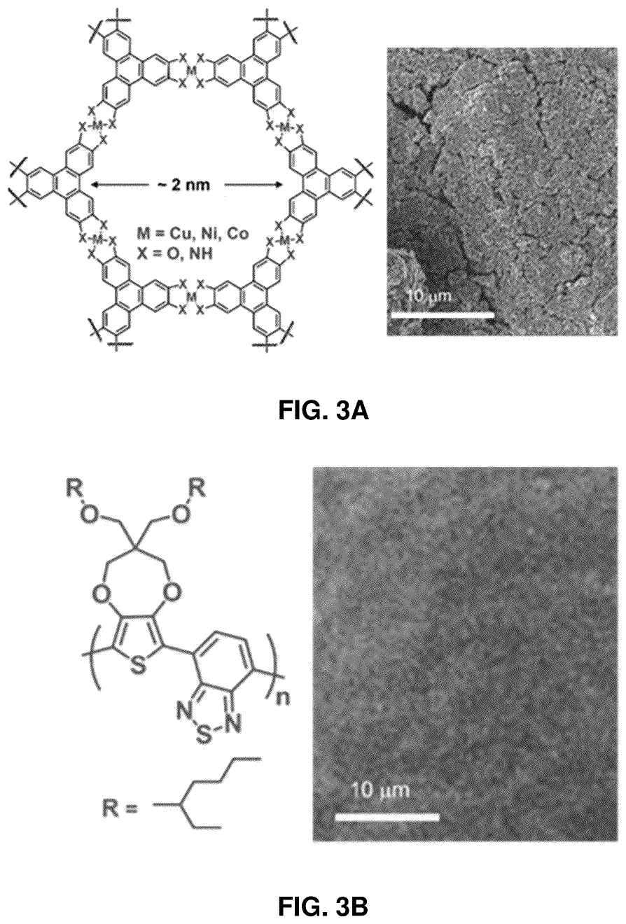

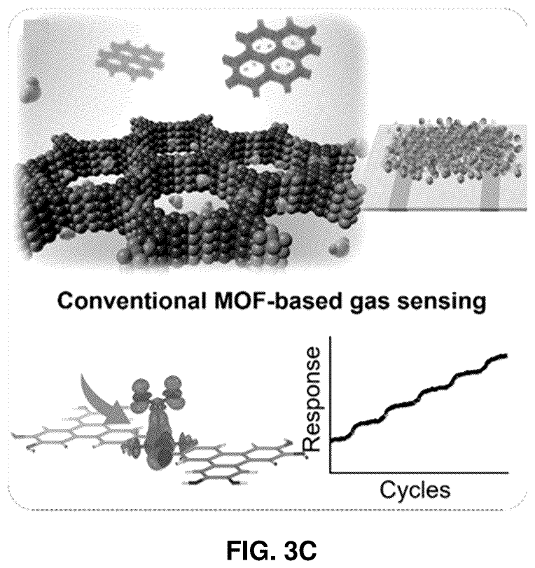

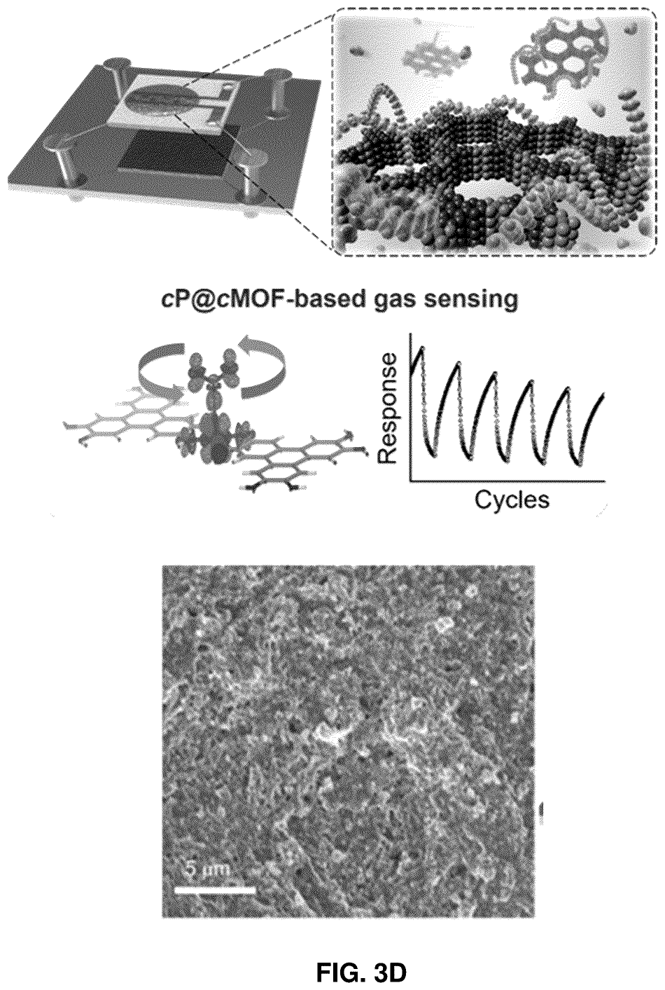

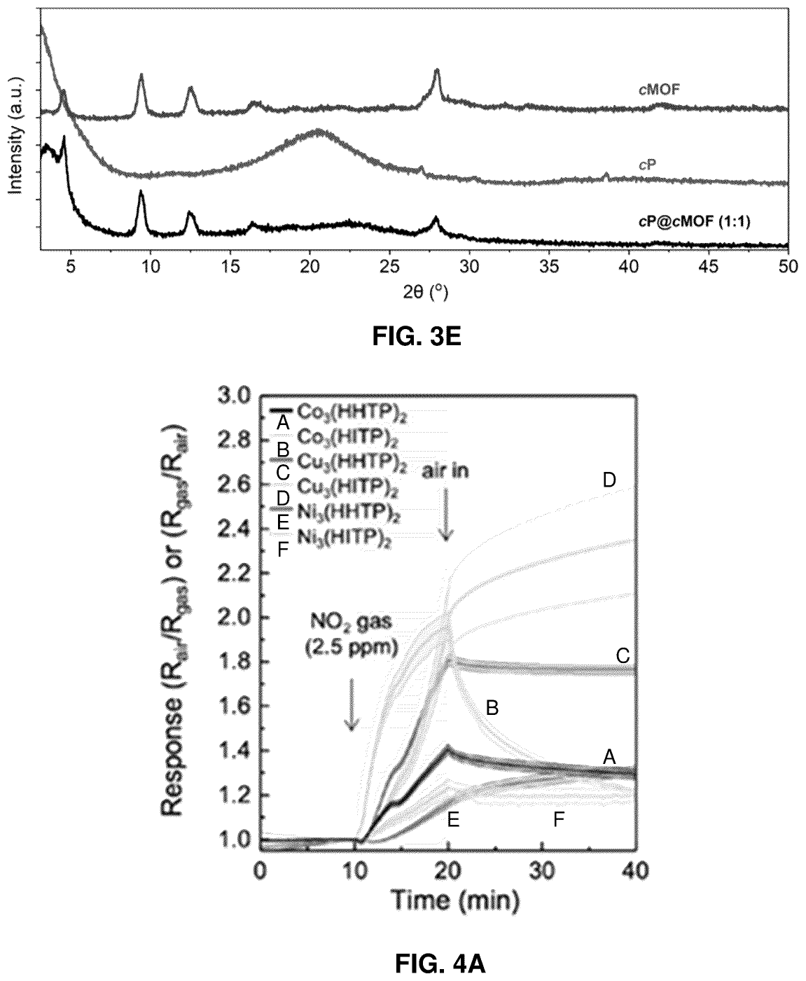

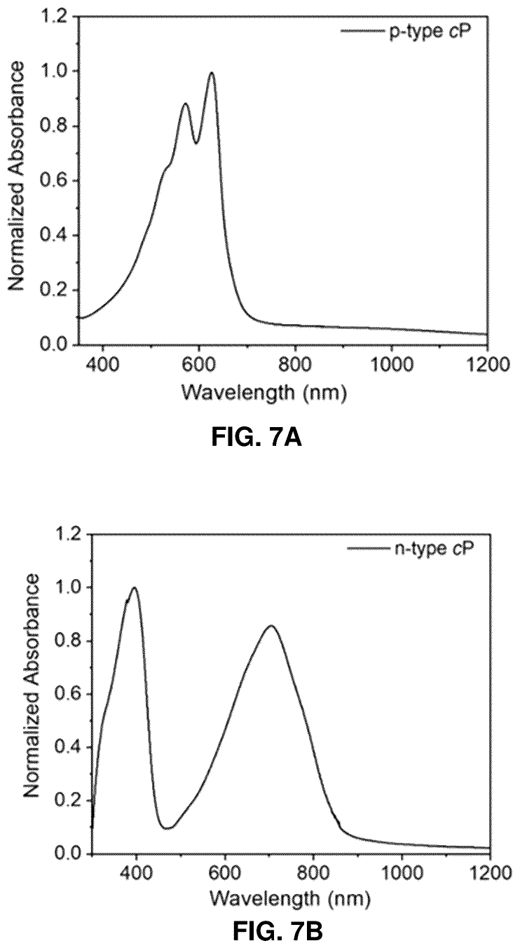

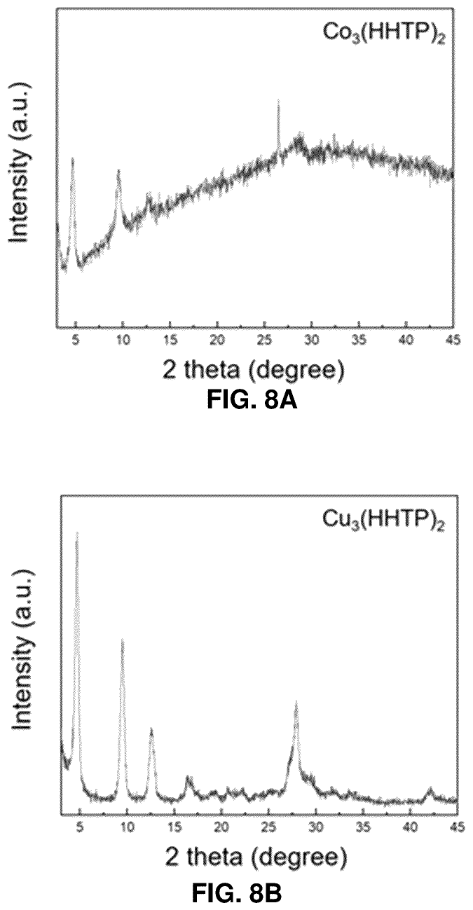

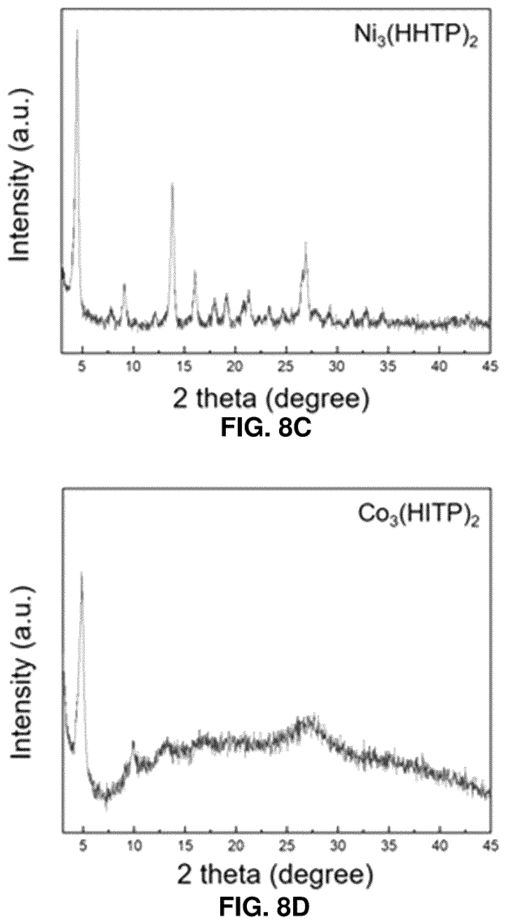

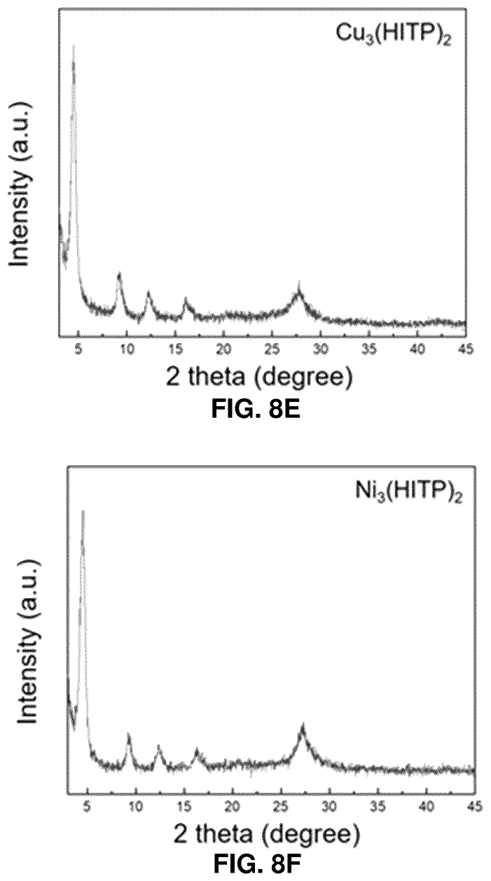

Designing conductive polymer/MOF films for chemiresistive devices: To form the polymer/MOF composite, a semicrystalline, mixed ionic-electronic conductive polymer (cP) based on 3,4-propylenedioxythiophene (ProDOT) and 2,1,3-benzothiadiazole (BTD) was used to form hybrid films with 2D cMOFs (FIGS. 3A-3D, 7A-7B, and 8A-8F). The ProDOT-BTD cP was selected for its reversible redox-activity, low onset oxidation voltage, high ion-compatibility and charge capacity, and electrical conductivity to enhance the device response in presence of the analyte. Particularly, the cP was designed to serve as a secondary NO₂-affine component endowed by its polar sidechains, as well as a binding matrix to physically unify cMOFs crystallites and improve electrical communication throughout the bulk (FIG. 3D). Two classes of cMOFs were selected based on 2,3,6,7,10,11-hexahydroxytriphenylene (HHTP) and 2,3,6,7,10,11-hexaiminotripphenylene (HITP) ligands (FIG. 3A), which typically exhibit irreversible gas sensing behaviors in their pristine form. As shown in FIGS. 3E and 8A-8F, the X-ray diffraction peaks corresponding to pristine cMOFs remained unchanged upon hybridization without peak shifts, indicating that the structure of the cMOF remained undisturbed and well-preserved. Next, the diverse metal nodes were assessed. All six cMOF combinations, namely M₃(ligand)₂, where M is either Co, Ni, or Cu and the ligand HHTP (X=O) or HITP (X=NH), were first synthesized and respective structures were verified through PXRD analysis (FIGS. 8A-8F).

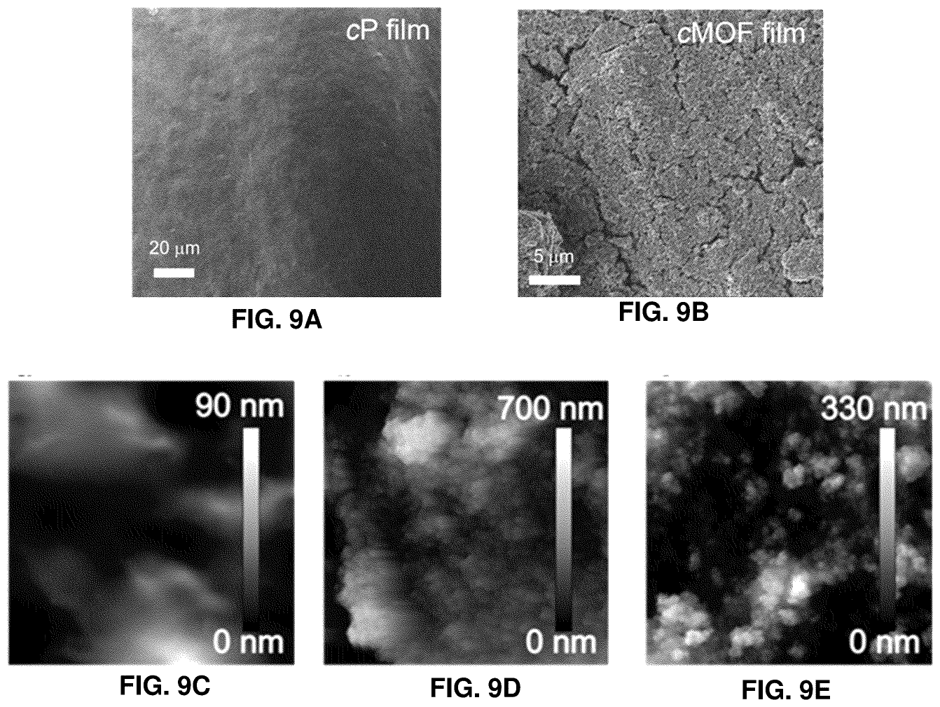

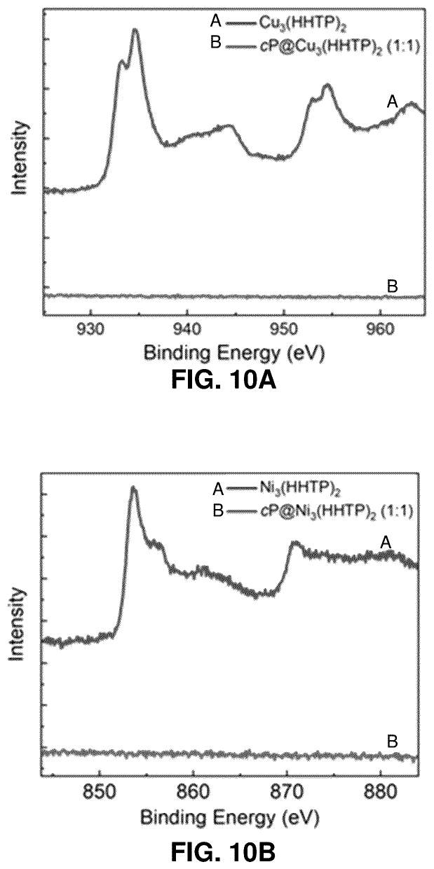

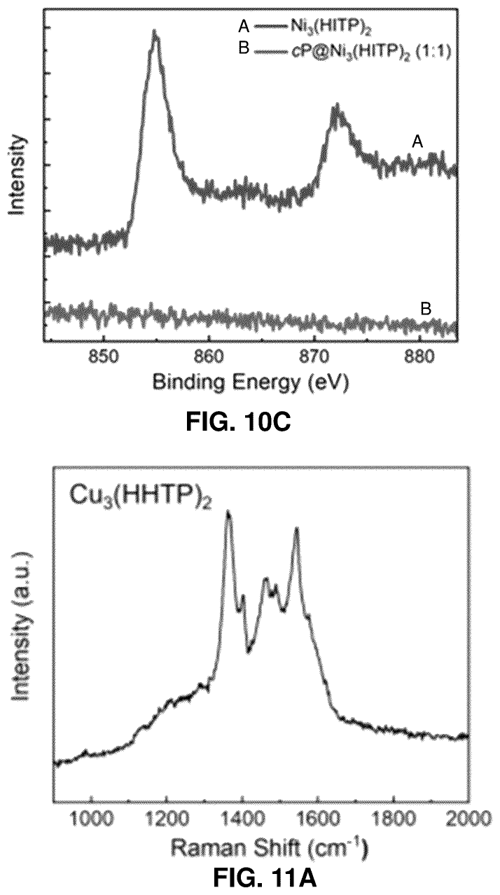

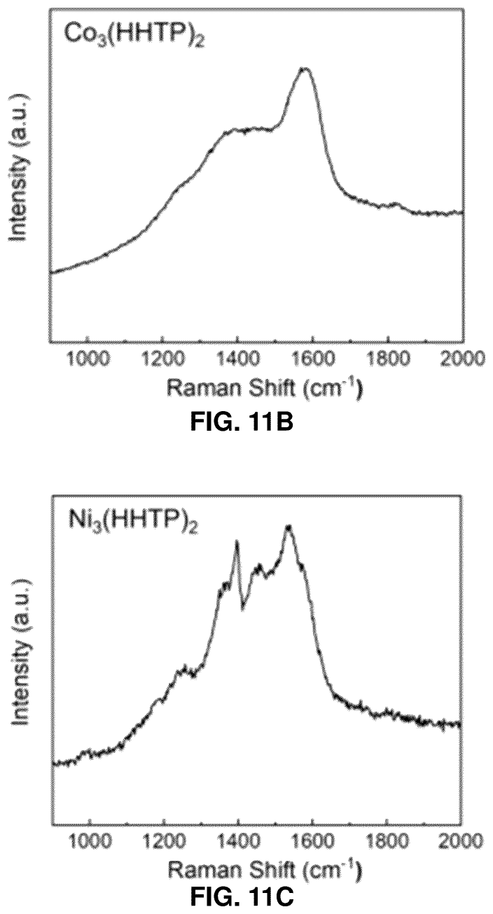

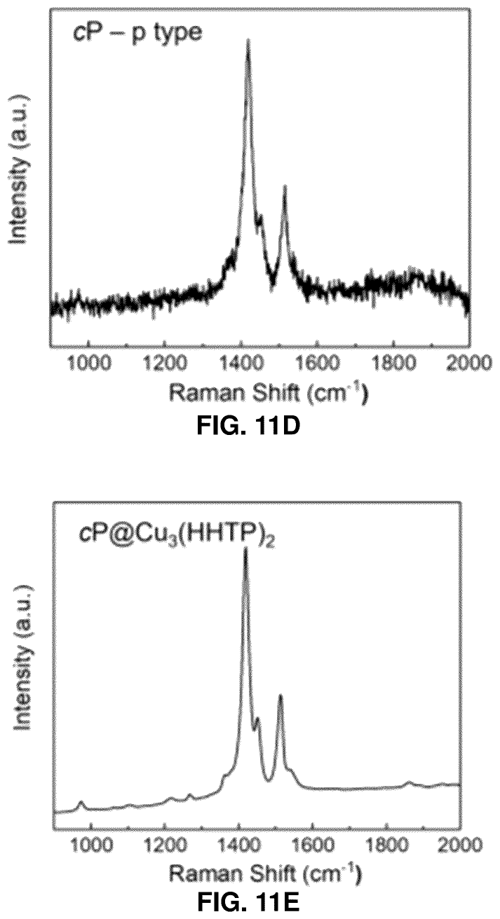

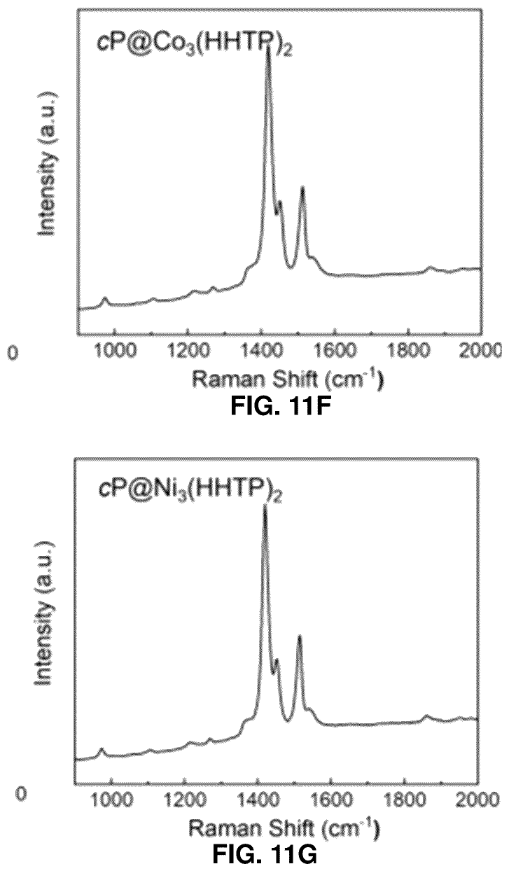

SEM images showed that the hybrid cP@cMOFs films were homogeneous and cMOFs crystallites are uniformly embedded in the cP matrix (e.g., cP@Cu₃HHTP₂, FIG. 3D). This was in contrast with pristine cMOF films which show micro-cracks and pristine cP with a smooth texture (FIGS. 3A-3B). AFM imaging was also used to compare surface roughness of drop-casted films, revealing smoother surfaces in cP@cMOFs compared to pristine cMOFs with Rq values of 97.5 nm and 195 nm, respectively, owing to the presence of the cP with Rq value of 22.7 nm (FIGS. 9A-9E). Furthermore, as corroborated by surface analysis using XPS and Raman spectroscopy (probing depths of 10 nm and 645 nm, respectively), the cP constituted most of the outermost layer of the composite films (at least ˜10 nm), engulfing cMOFs crystallites. At such shallow depths, the distinctive metal peaks from the cMOF component were absent in high-resolution XPS spectra of hybrid films (FIGS. 10A-10C). At the same time, corresponding Raman spectra were identical to that of pristine cP (FIGS. 11A-11G) indicative of a predominantly polymer-enriched interface in the hybrid films. It was hypothesized that, with this architecture, the semicrystalline and NO₂-affine polymer would also contribute to the adsorption of gas molecules into sensor's channel area and enhance the overall sensitivity of the sensors. That is, i) the conductive backbone was flanked with polar sidechains favoring the permeability of gas molecules into the active area across entire active channel, and ii) cP served as a conductive matrix binding MOF crystallites throughout the bulk thus promoting efficient charge transport upon resistance change. By interlinking the crystallites throughout the film bulk, the cP thus helped reduce inter-particle resistance, a dominant behavior in pristine MOFs, and enhanced the performance of chemiresistors based on polymer/MOF composites (FIG. 3D). The pasty nature of the solution processed cP also promoted greater film integrity, device reliability, and stability.

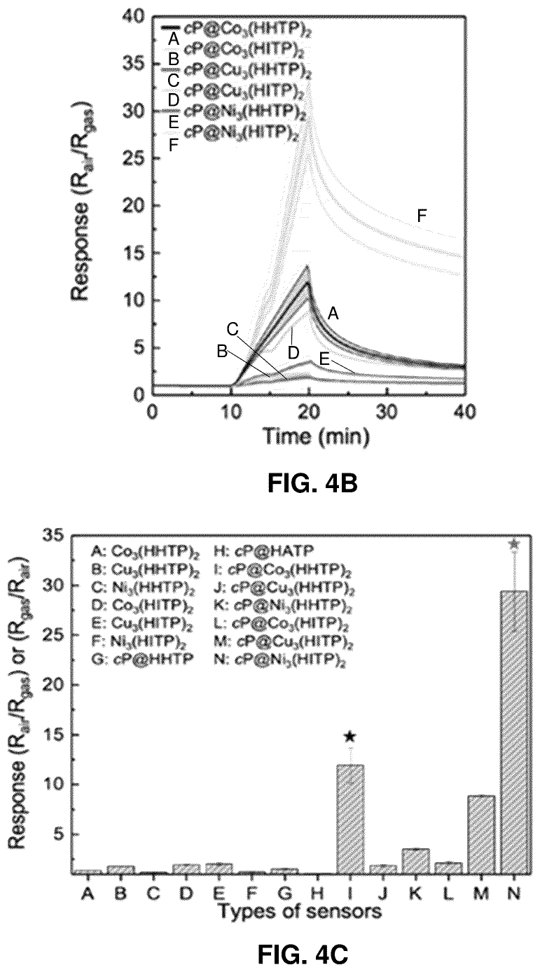

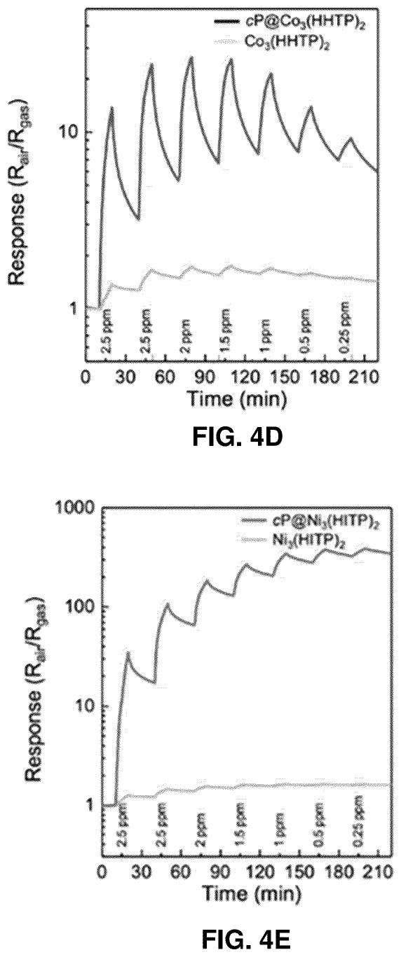

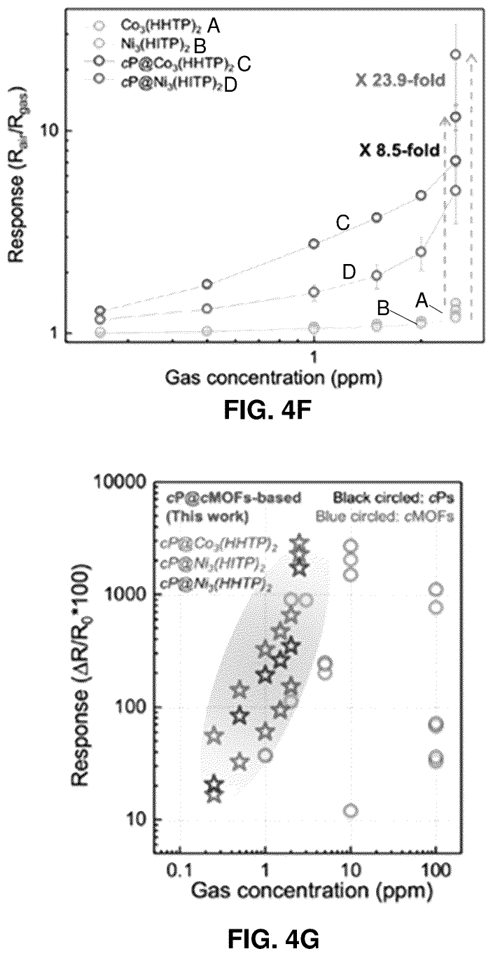

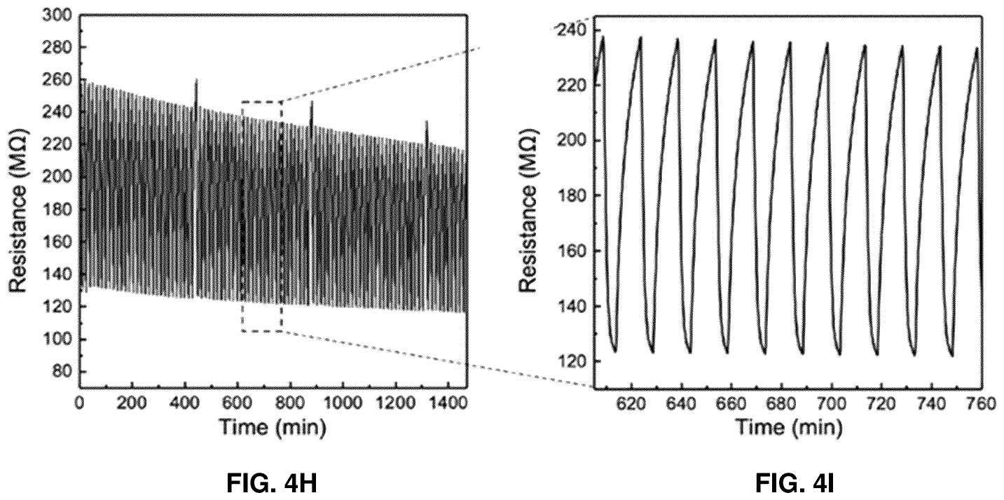

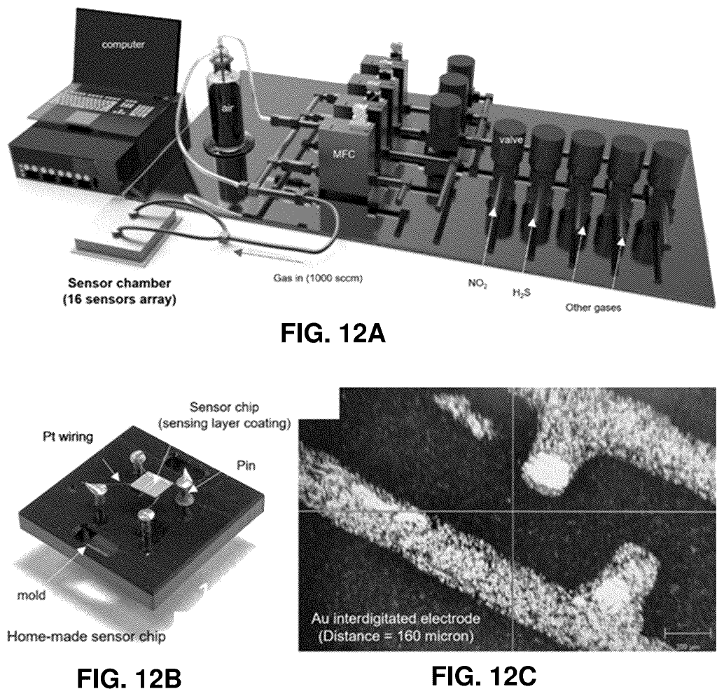

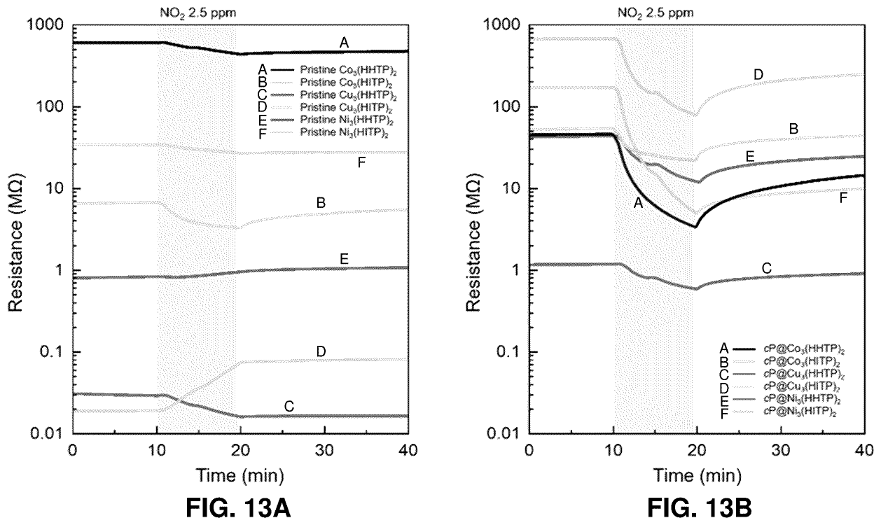

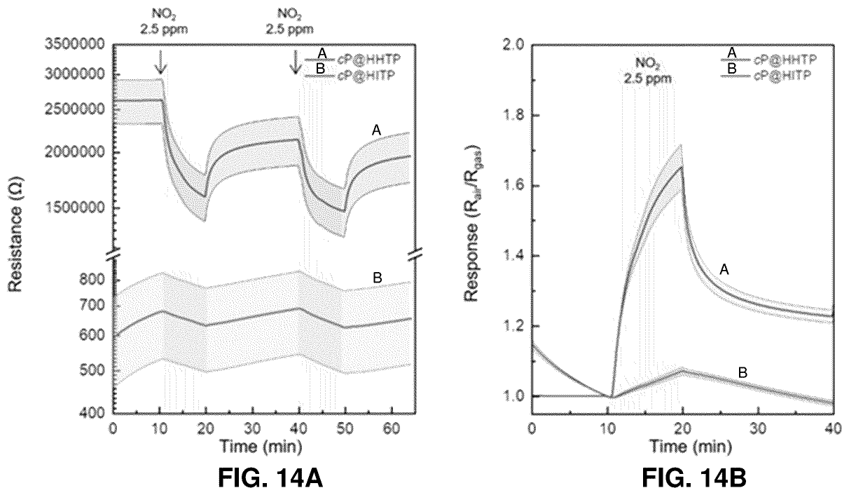

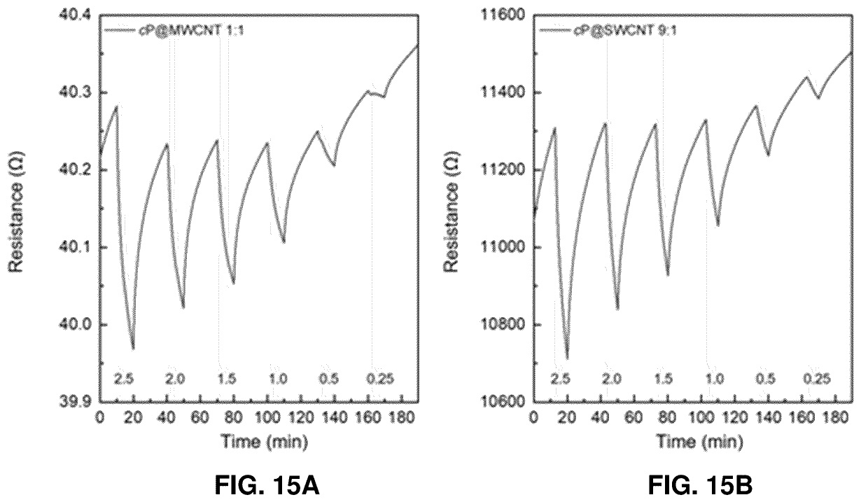

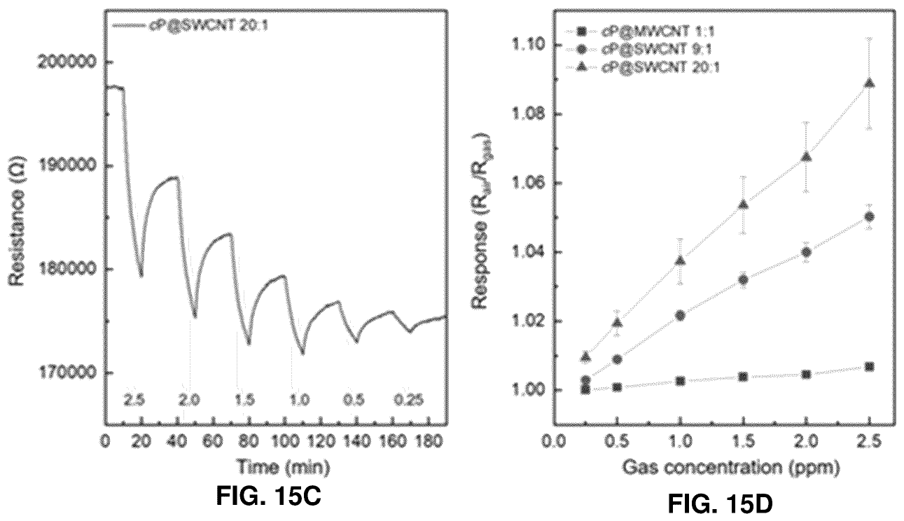

Gas sensing performance of cP@cMOFs: To test the effect of hybridization on gas sensing performance, chemiresistive sensors were fabricated using the cP@cMOFs combinations discussed above. Further details on the sensor fabrication steps and device dimensions are illustrated in FIGS. 12A-12C. As shown in FIG. 4A, the sensors based on pristine cMOFs exhibited relatively low responses (Rₐᵢᵣ/R_{gas} or R_{gas}/Rₐᵢᵣ<˜2, where Rₐᵢᵣ and R_{gas} denote resistance in air and gas, respectively) and poor sensing reversibility. Upon hybridization with cP (e.g., 1:1 weight ratio between cP and cMOF), the sensing response, and the sensing reversibility were significantly enhanced across all cMOFs (FIGS. 4A-4C and 13A-13B). This performance enhancement was exemplified in cP@Ni₃(HITP)₂ exhibiting a 23.9-fold improvement in sensor response relative to pristine Ni₃(HITP)₂ (FIG. 4C). Note that, in its pristine form the cP yielded sensors with an undetectable response, and the same effect was not induced when the hybridization was done with corresponding ligands (HHTP or HITP) instead of cMOFs or other conventional conductive materials such as carbon nanotubes (CNTs) (FIGS. 14A-14B and 15A-15D). This behavior thus suggests the utilization of a conductive polymer to hybridize with the porous cMOFs and synergistically enhance sensing response and reversibility.

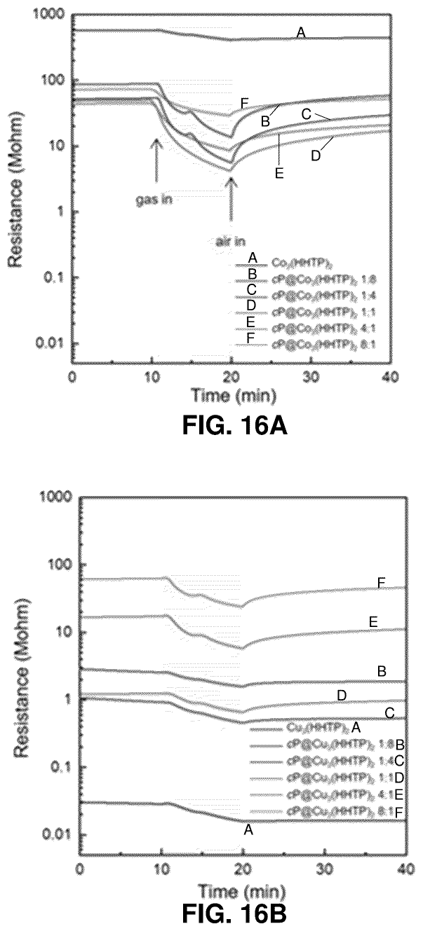

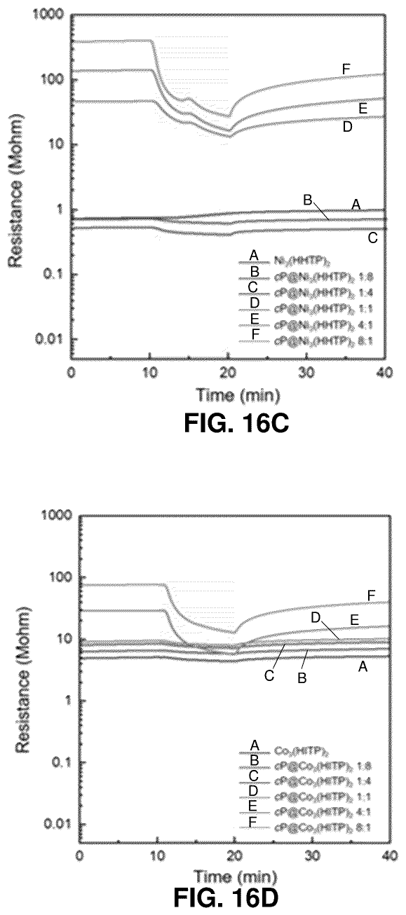

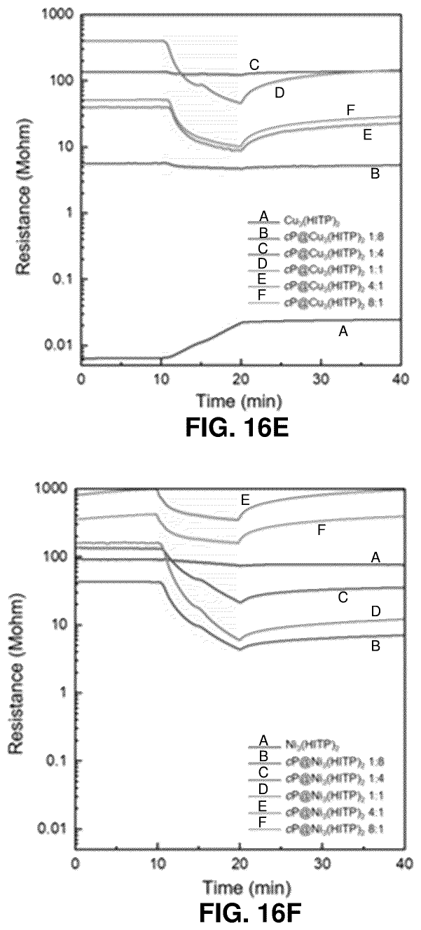

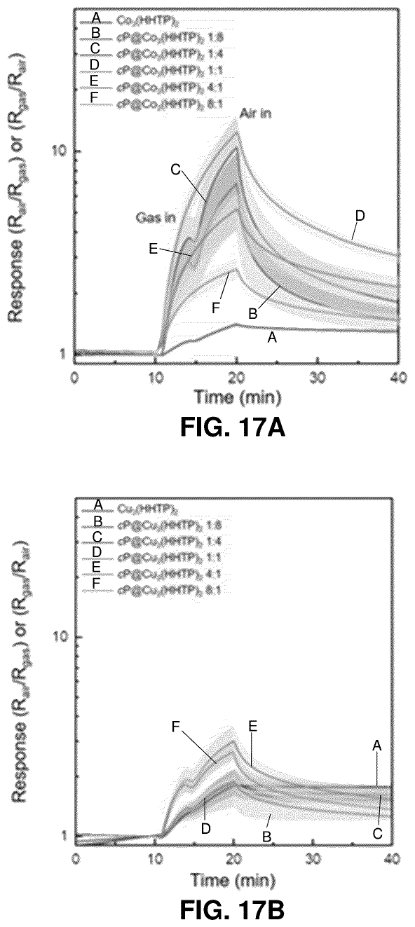

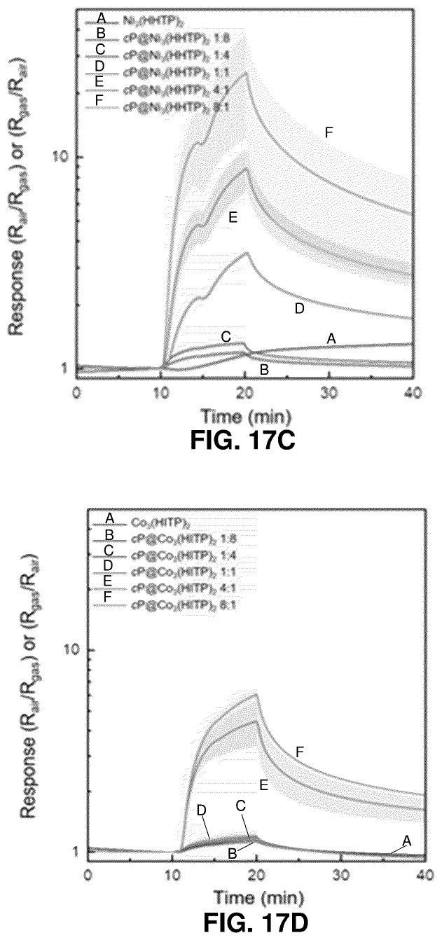

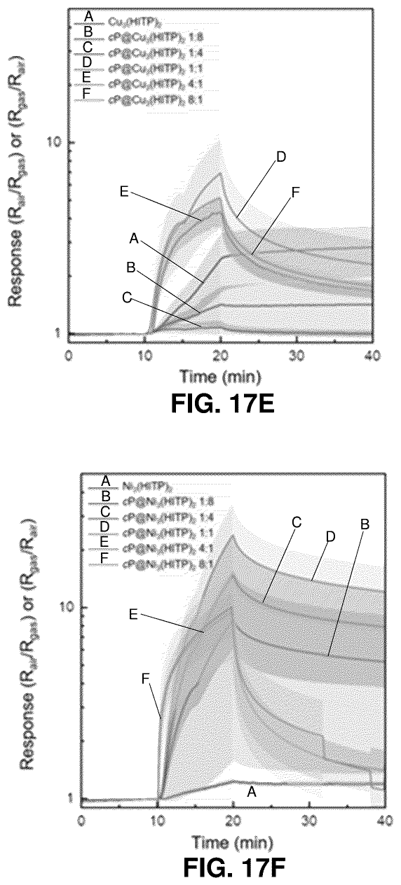

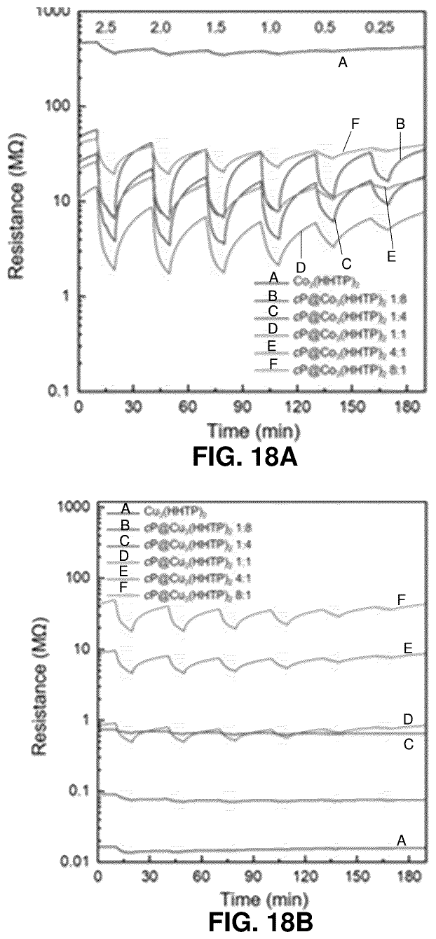

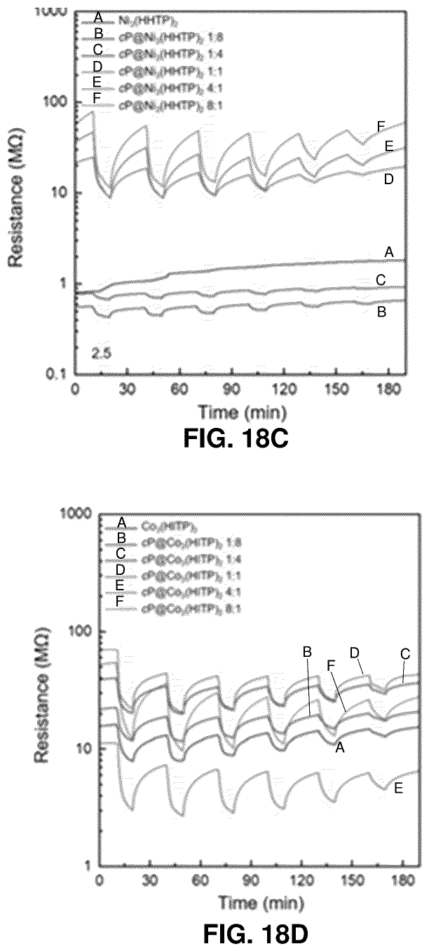

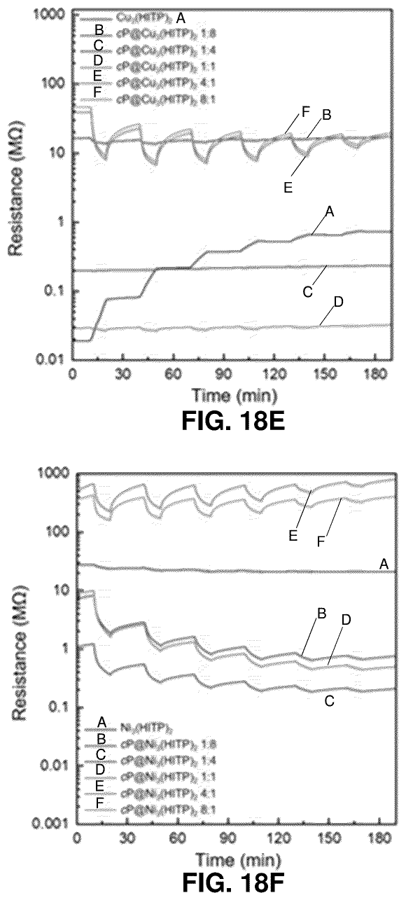

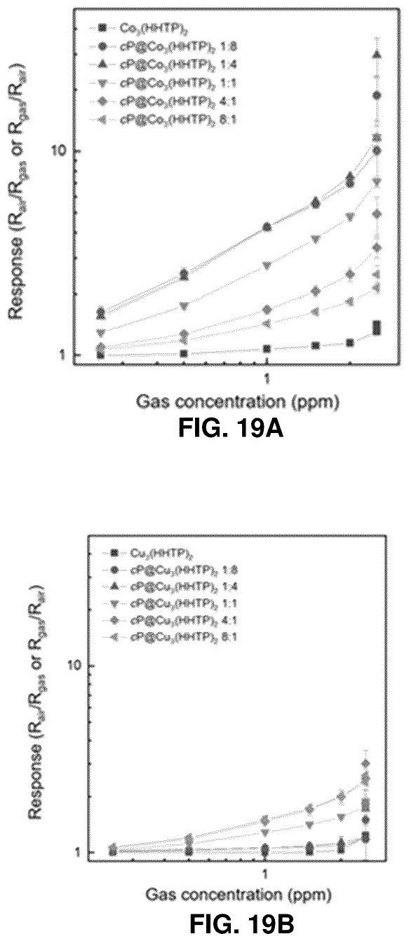

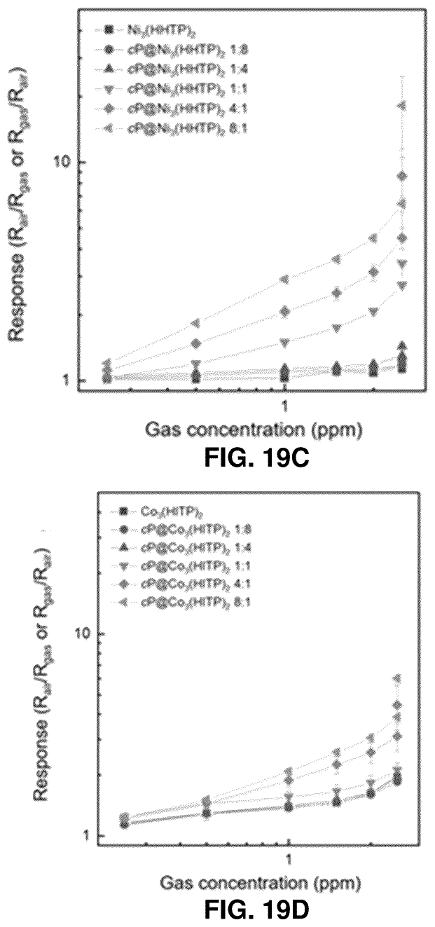

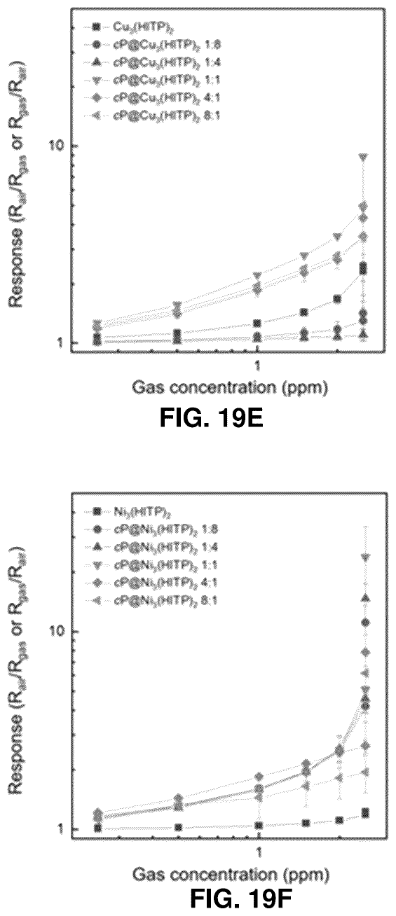

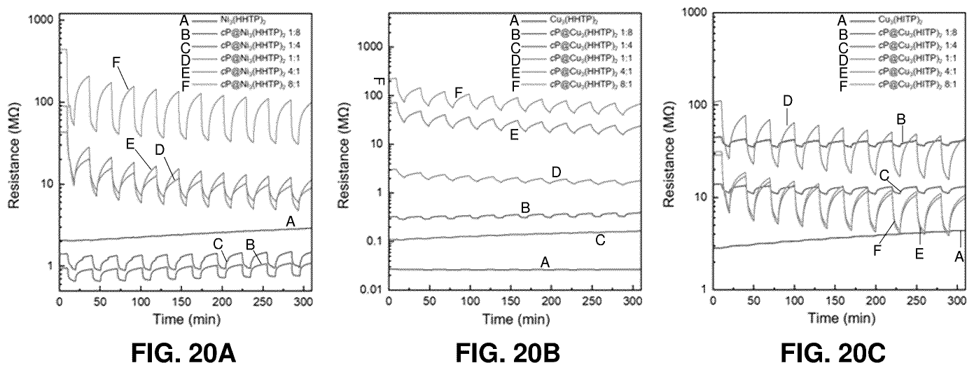

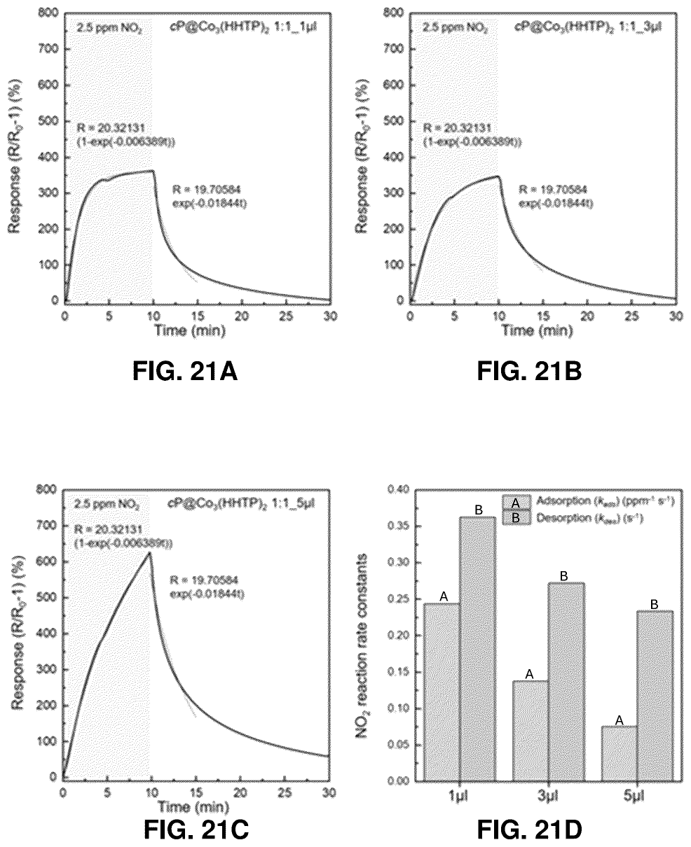

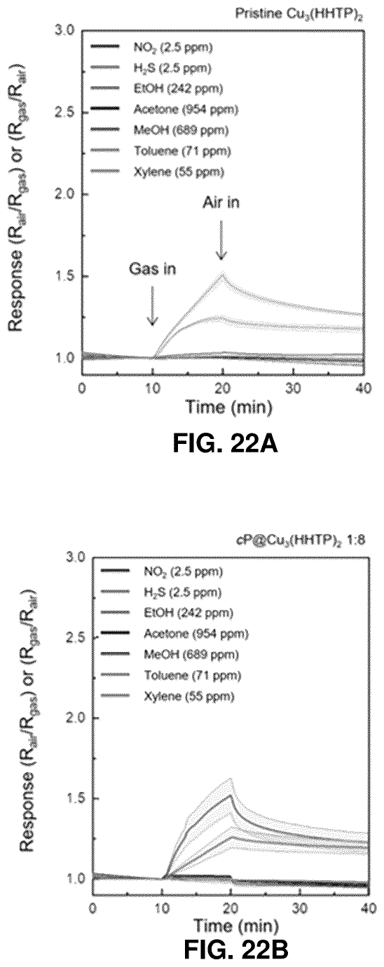

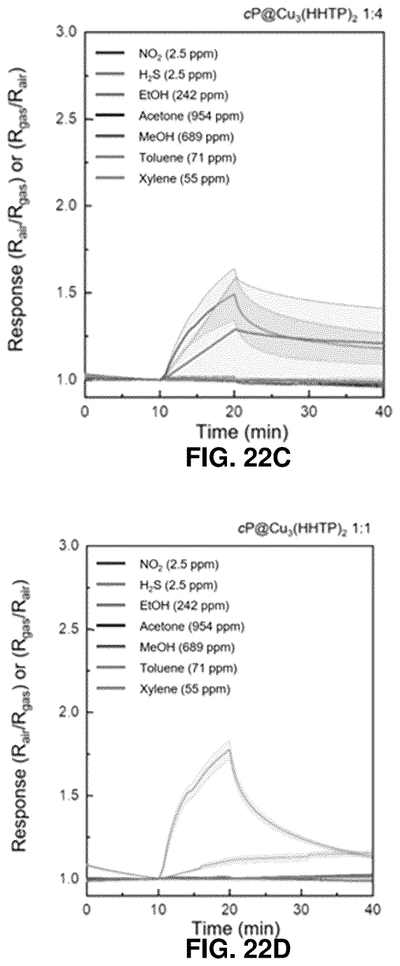

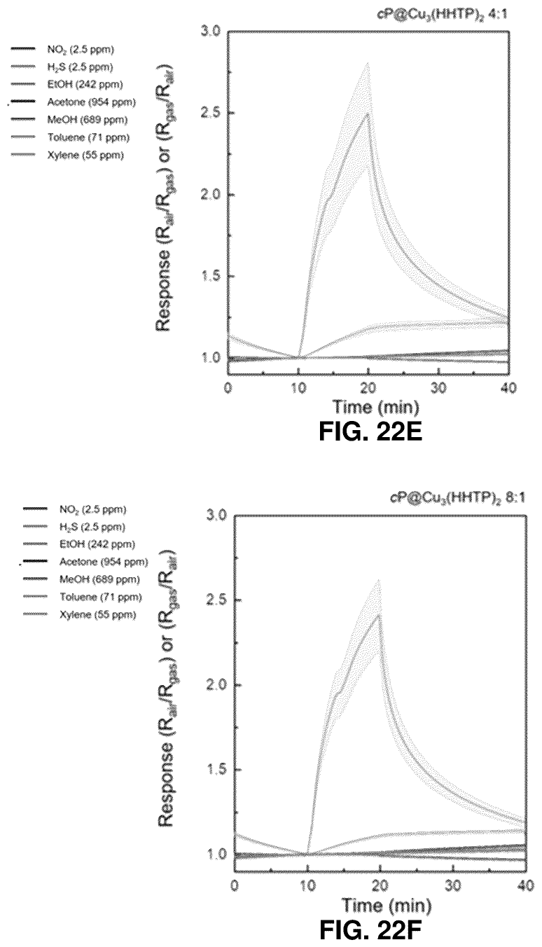

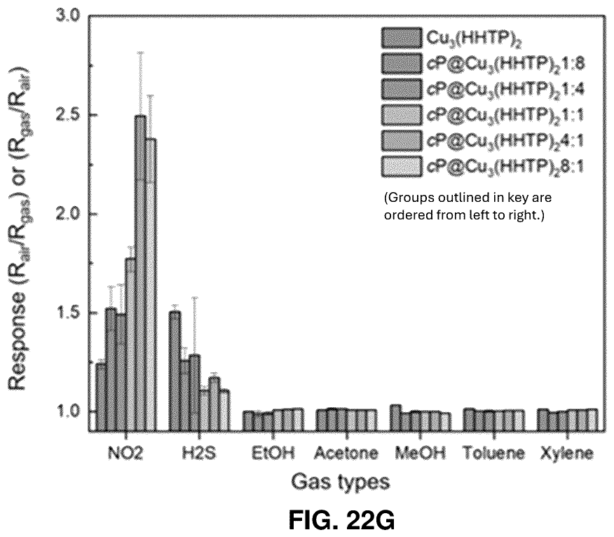

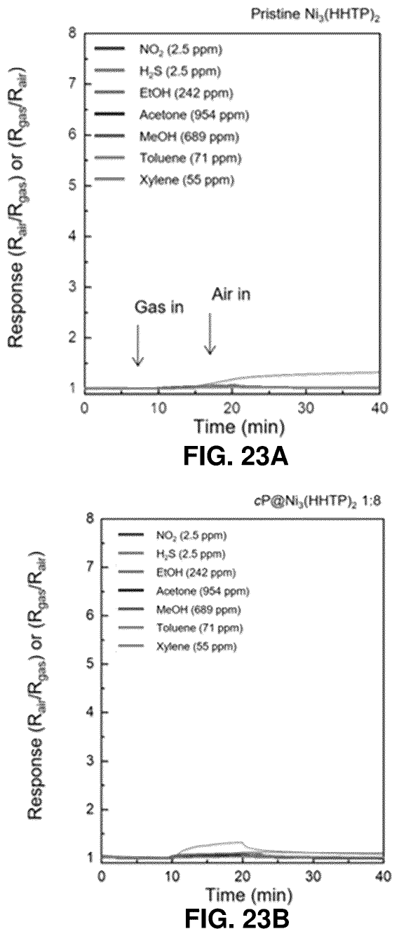

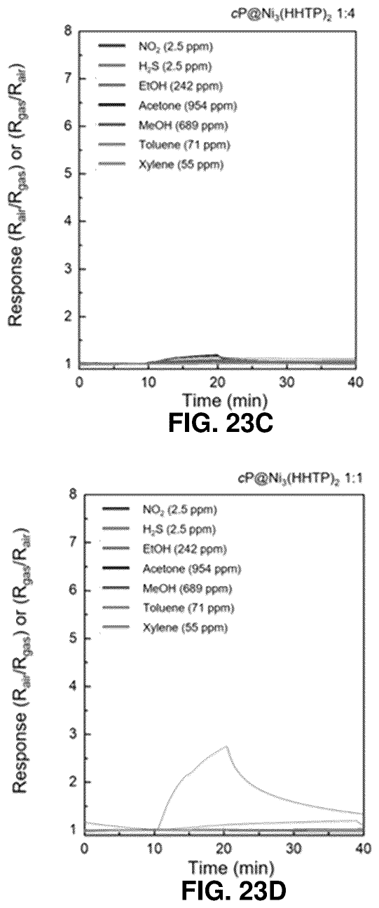

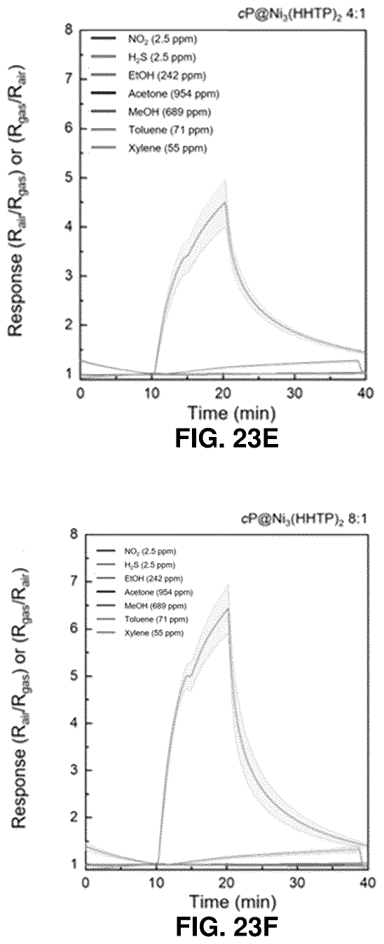

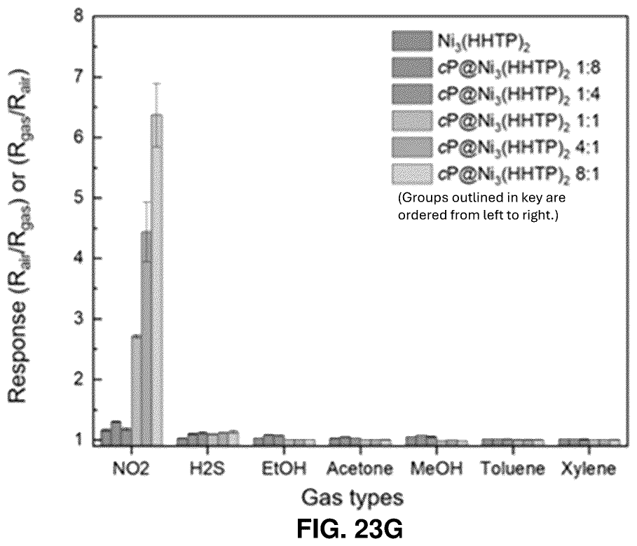

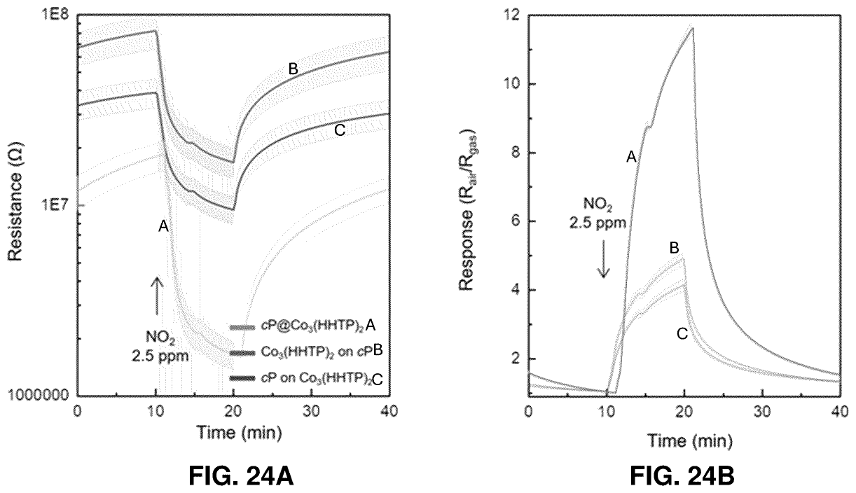

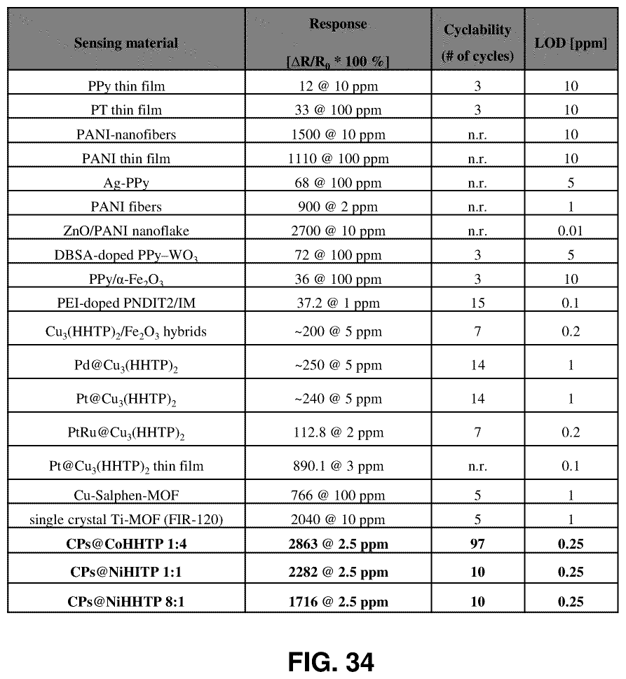

Furthermore, the hybridization was beneficial to the sensitivity level of the sensor devices as illustrated in the dynamic resistance changes with NO₂ concentrations down to 0.25 ppm (FIGS. 4D-4F). In terms of sensitivity, it was determined that, upon optimization of the cP content in the hybrid films (FIGS. 16A-16F, 17A-17F, 18A-18F, 19A-19F, 20A-20C, and 21A-21C), cP@Ni₃(HITP)₂ demonstrated the most pronounced initial response in the presence of NO₂, albeit its relatively modest reversibility compared to the cP@Co₃(HHTP)₂ analogue. Among all hybrid combinations, cP@Co₃(HHTP)₂ exhibited the highest dynamic resistive behavior and reversibility enhancement compared to its pristine counterpart. Nonetheless, across all six cMOFs, the hybridization showed to enhance the sensing response compared to pristine constituents (FIG. 4G) while conserving the selectivity level towards NO₂ gas (FIGS. 22A-22G and 23A-23G), given uniform distribution of the components within the bulk (FIGS. 24A-24B). Further, the cP@cMOFs-based sensors demonstrated enhanced cycling reversibility compared to their pristine counterparts (FIGS. 4H-4I, 16A-16F, and 20A-20C). Particularly, cP@Co₃(HHTP)₂-based sensors exhibit stable and reversible performance up to 97 cycles (FIGS. 4H-4I). These results represent the highest number of cycling tests with stable reversibility among all cMOFs- or cP-based chemiresistive sensors reported to date (FIG. 34).

The role of hole enrichment toward reversible NO₂ sensing: The electronic characteristic at the heterojunctions formed between cP and cMOFs, as well as the distribution of such heterojunctions throughout the bulk, was used to synergistically deploy both conductors in the hybrid films. The activation energy for charge carrier transport in response to NO₂ adsorption was used to enhance the sensing performance of hybrid films. The sensor reversibility was evaluated at room temperature by monitoring the channel resistance recovery before and after NO₂ exposure. As previously noted and confirmed by solid state characterizations, the structural configuration of the hybrid film (i.e., lowered film crystallinity and uniform distribution of cMOF crystallites within the cP bulk) accounted for enhancement in sensitivity and retention. Given that the cP@cMOFs-based sensors also exhibit excellent signal recovery, the next step was to mechanistically understand the impact of these features on the adsorption and desorption kinetics of NO₂ gas. In conventional MOF-based NO₂ sensors, reducing the sensor response times and, more importantly, increasing the desorption rate constant (k_{des}) to achieve reversible sensing has been challenging.

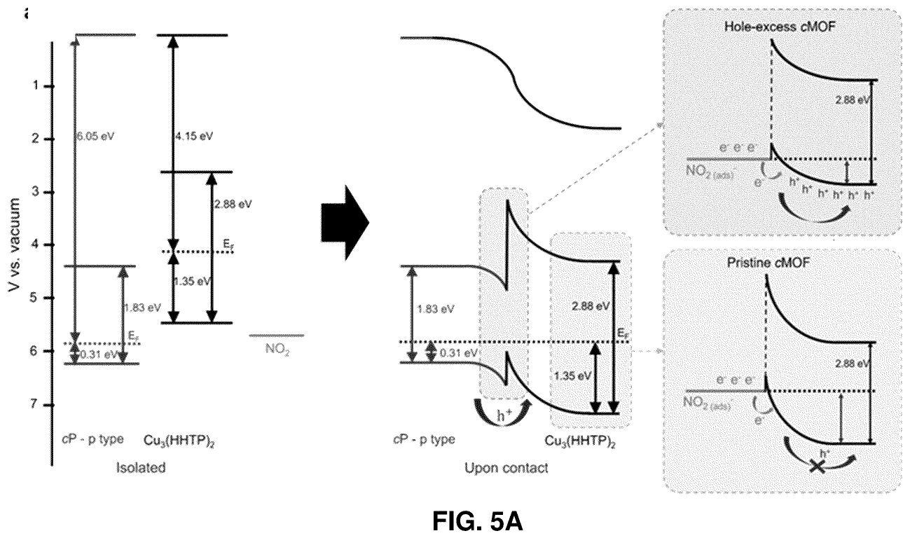

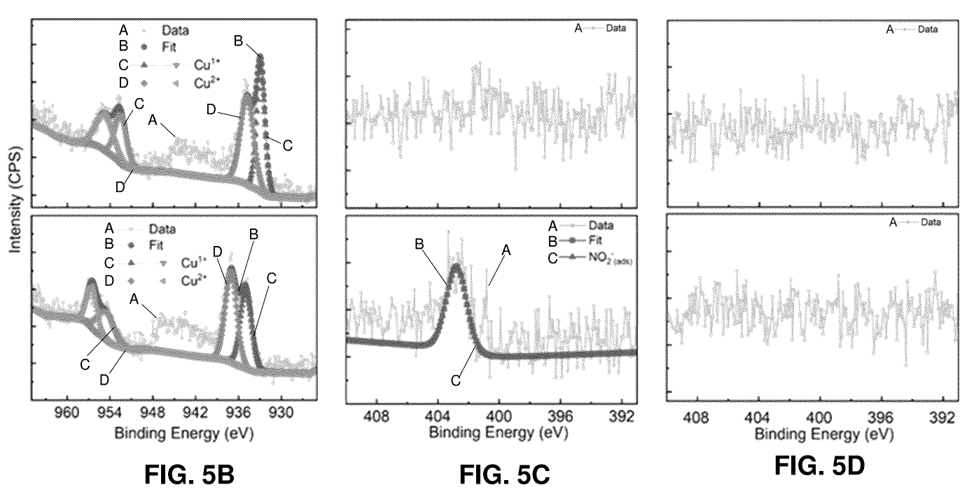

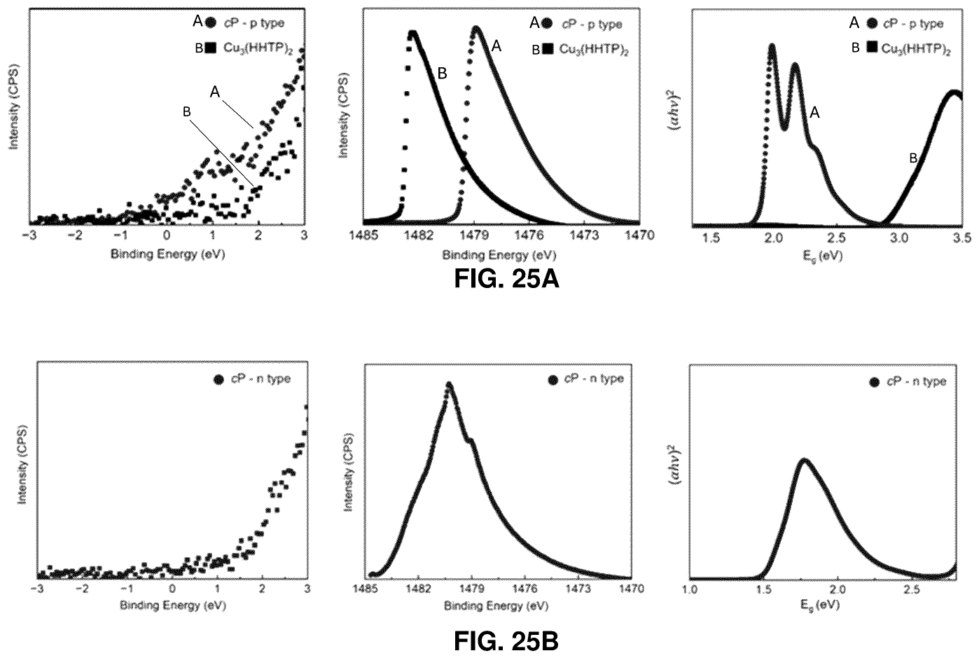

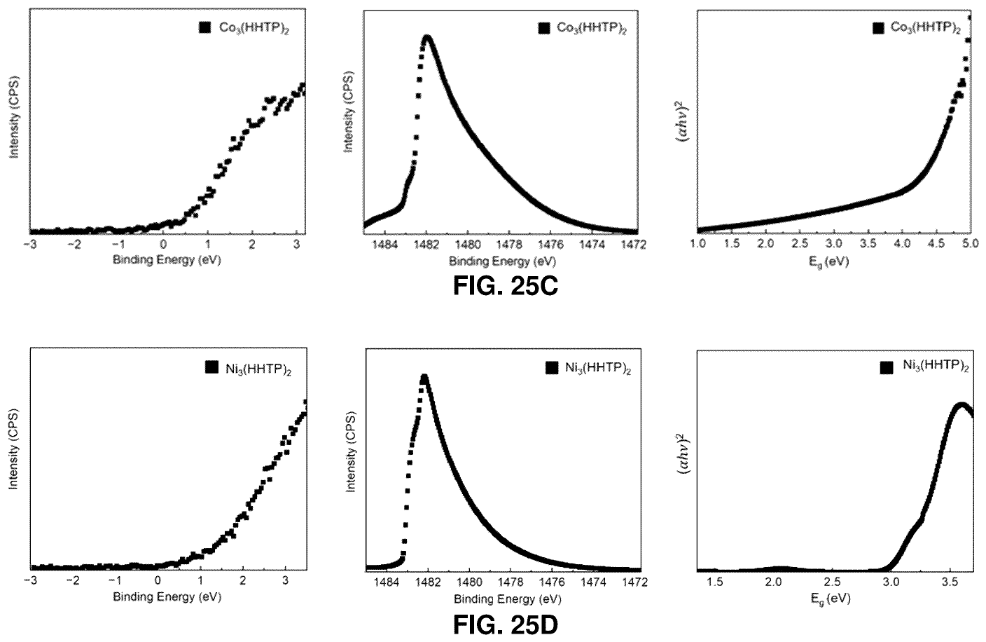

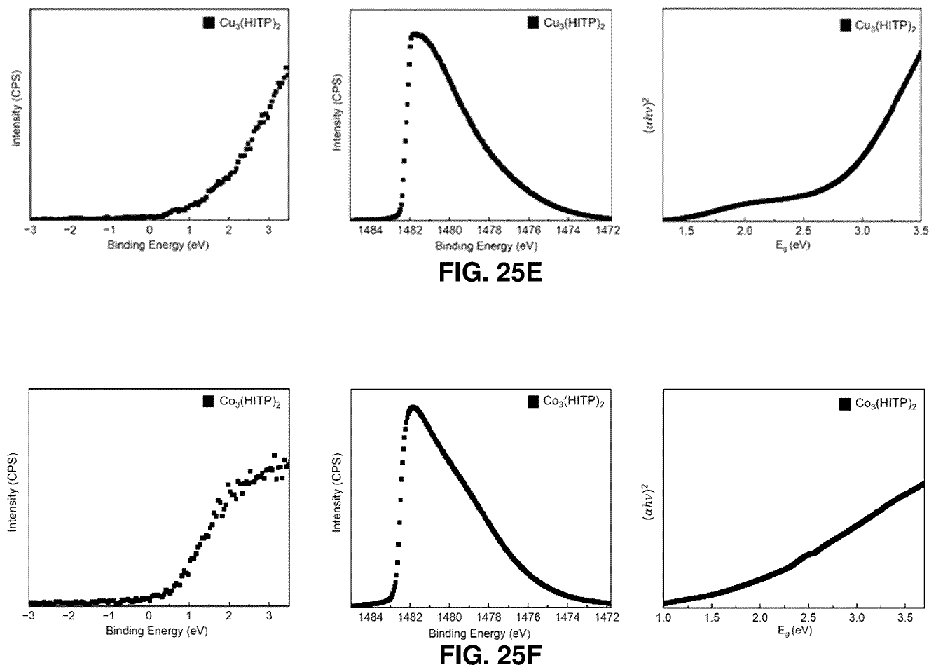

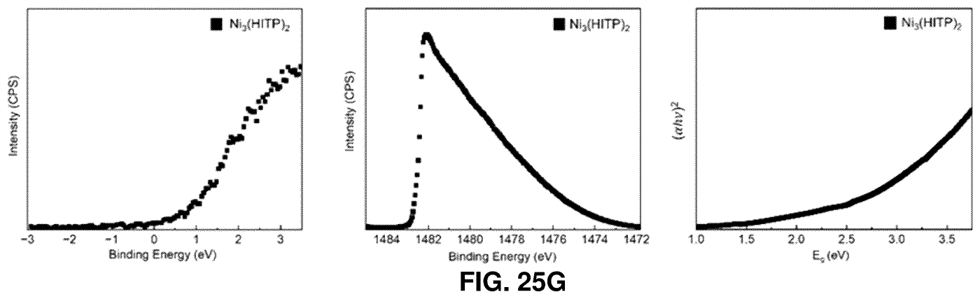

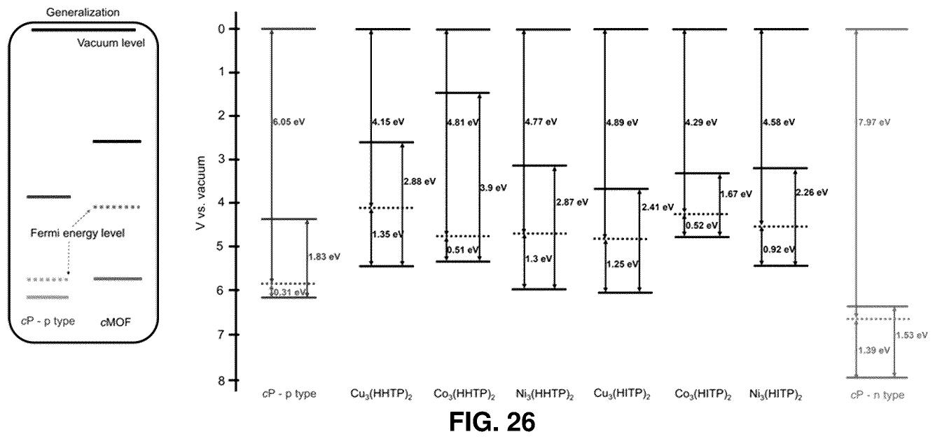

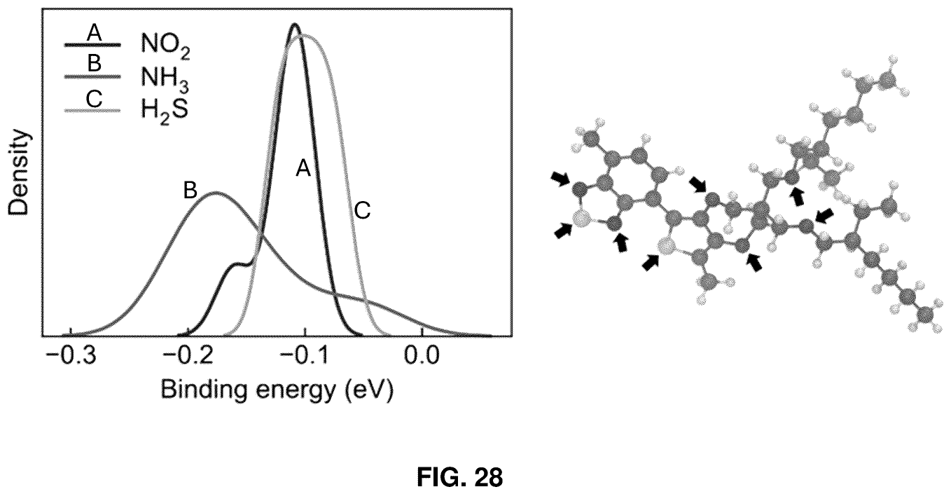

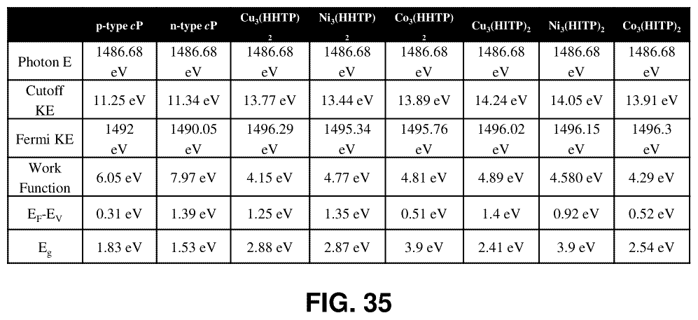

Without relying on external stimuli or addition of inactive components, the newly designed cP@cMOFs hybridization provided a thermodynamic solution to irreversible detection of NO₂. The experimentally constructed energy band diagrams showing respective HOMO levels with respect to fermi level reveal p-type cP as the most hole-rich component (FIGS. 5A, 25A-25G, 26, and 35). In all studied cMOF cases, the two materials were energetically close enough, which suggested that, upon hybridization, beyond the formation of microscopic interfaces throughout the bulk, the cP-cMOF heterojunctions established an electronic equilibrium, and the majority carriers occupied a shared Fermi level (FIG. 5A). In other words, a hole transfer from the cP to the cMOF was thermodynamically favorable forming a hybrid and hole-enriched cMOF state (FIGS. 5A, 26, and 27). This injection of holes into the cMOF's electronic configuration altered the interaction between NO₂ and the sensing channel by lowering the binding energy (the primary source of irreversible sensing, FIG. 28), which resulted in reversible sensing behavior, even at room temperature (FIG. 5A). Prior to this work, the desorption of NO₂ gas from MOF sorbate materials was conventionally achieved using elevated temperatures, high energy radiation, or the incorporation of heavy metals in the active layer. The hybridization strategy described herein is more straightforward and holds potential for generalization onto essentially any conductive MOF structure.

To test the proposed working mechanism, the XPS spectra of the active material was examined before and after NO₂ exposure. The oxidative effect of NO₂ on the sensing materials was evidenced by subsequent charge redistribution around the metal nodes to compensate the charge imbalance. High-resolution XPS spectra of the characteristic metal peaks (e.g., Cu 2p) revealed a significant change in the ratio between oxidation states of the metal (e.g., Cu¹⁺ and Cu²⁺). In the case of Cu₃(HHTP)₂ films, substantial change in the oxidation state of the Cu was evidenced by a decrease in the Cu¹⁺ (˜933 eV)/Cu²⁺ (˜935 eV) ratio from 1.17 to 1.09 after exposure to NO₂ (FIG. 5B). Concomitantly, in the pristine MOF samples, despite the high vacuum conditions during XPS measurements, the adsorption and binding of NO₂ molecules was evidenced by a signature peak at 403.9 eV (FIG. 5C). In contrast, the hybrid films exhibited no discernable signal from this N 1s peak within the same desorption timescale (FIG. 5D), indicative of nearly complete desorption of NO₂ gas from the hybrid films. This complete desorption was associated to the formation of a new Fermi level upon hole enrichment, which weakened the binding between the gas molecules and the cMOF sites. This labile binding between NO₂ molecules and the cP@cMOFs films is thus a rationale to the observed dynamic response in the chemiresistive sensors.

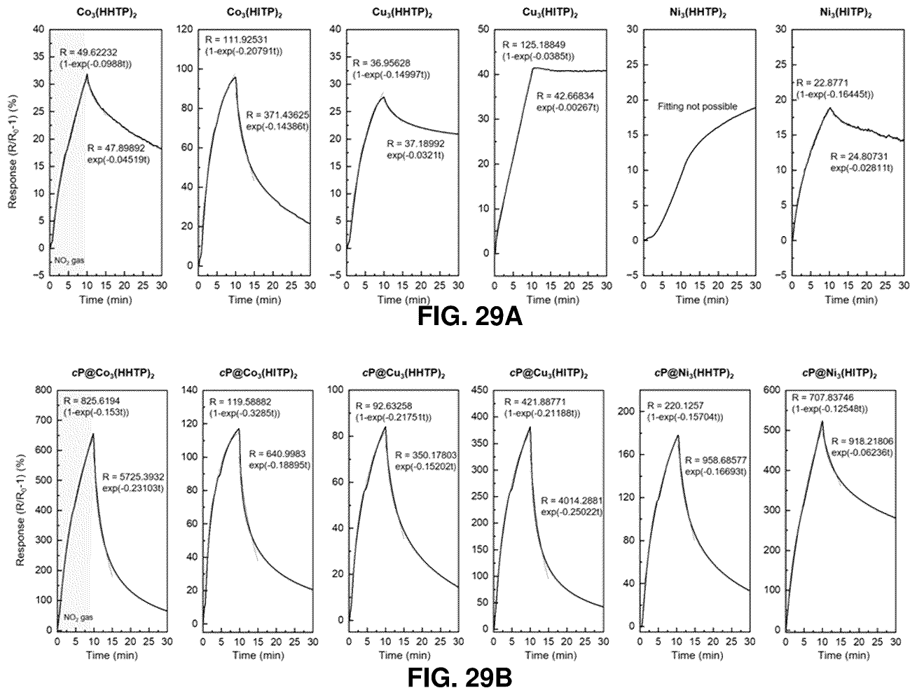

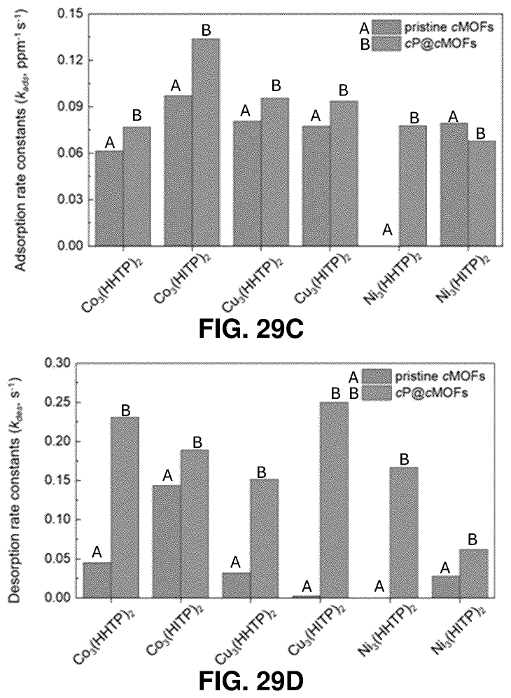

The sensing mechanism was further corroborated by experimentally monitoring the sensor's recovery kinetics upon hybridization. A mass action law of gas adsorption reactions was employed on both cMOFs and cP@cMOFs and the response and recovery kinetics for NO₂ sensing was computed. The calculations assumed that the quantity of gas adsorbed on the surface was directly related to the sensors' response. The respective rate constants were then calculated (i.e., k_{ads} for gas adsorption and k_{des} for the desorption) by fitting the sensor's response graphs using equations (1) and (2) below for six distinct cMOFs and corresponding cP@cMOFs (FIGS. 29A-29D):

$$R ( t ) for {NO}_{2} adsorption = {R}_{max} \cdot \frac{{C}_{a} K}{1 + {C}_{a} K} ( 1 - exp [ - \frac{1 + {C}_{g} K}{K} \cdot {k}_{ads} t ] ) , \qquad ( 1 )$$

$$R ( t ) for {NO}_{2} desorption = {R}_{0} exp [ - {k}_{des} t ] , \qquad ( 2 )$$

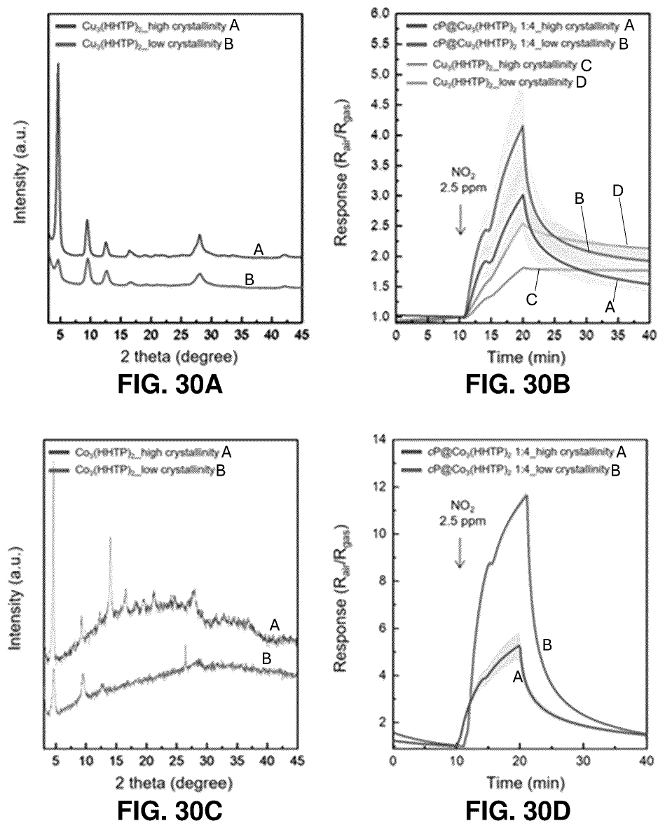

Here, R₀ serves as the baseline response in baseline air, Rₘₐₓ is the maximum response, Cₐ is the gas concentration, t is time, and K is an equilibrium constant (k_{ads}/k_{des}). In all cases, cP@cMOFs displayed improved desorption kinetics compared to their corresponding pristine cMOFs counterparts. The k_{des} for cP@Cu₃(HITP)₂ was measured to be 93.7-fold higher compared to that of pristine Cu₃(HITP)₂. Further, the k_{ads} values for cP@cMOFs exhibited minimal changes when compared to those of pristine cMOFs. This suggested that the dominant factor for enhancing reversibility in the composite systems was the thermodynamic effect from the hole enrichment, rather than structural factors. Note that for Cu₃(HITP)₂ and Ni₃(HHTP)₂, which showed n-type resistive variation upon NO₂ exposure (oxidizing gas), a higher amount of cP was required than other cMOFs to achieve the optimal ratio for reversibility (FIGS. 16A-16F, 17A-17F, 18A-18F, and 20A-20C). Serendipitously, these two systems also exhibited larger (E_{F}−E_{V}) values relative to the cP in energy level diagram, making the hole enrichment more energy consuming. With the same rationale, superior room temperature reversibility was observed in pristine Co-based cMOFs compared to other pristine cMOFs and could be attributed to their notably lower (E_{F}−E_{V}) value (˜0.5 eV) (thus inherent abundance of hole carrier density), set aside lower crystallinity (FIGS. 30A-30D).

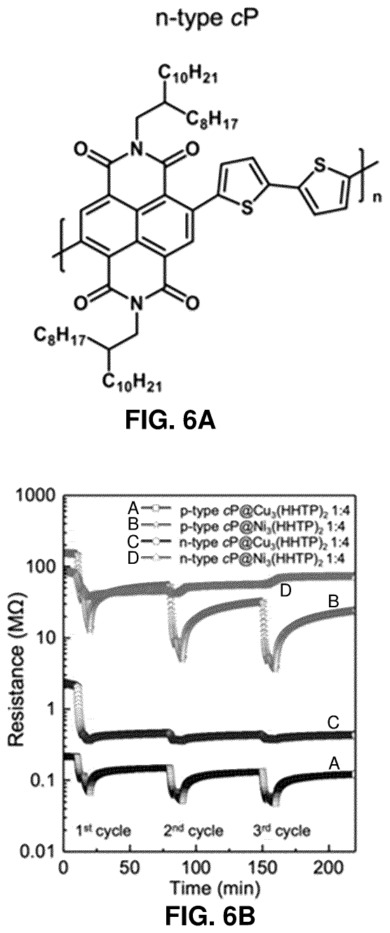

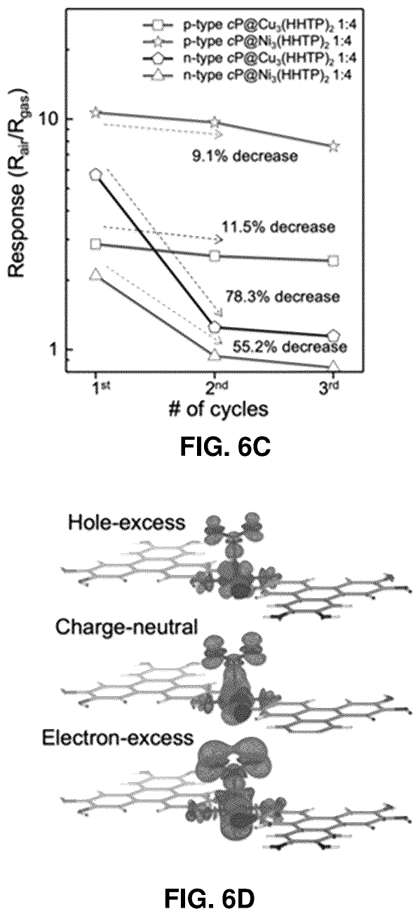

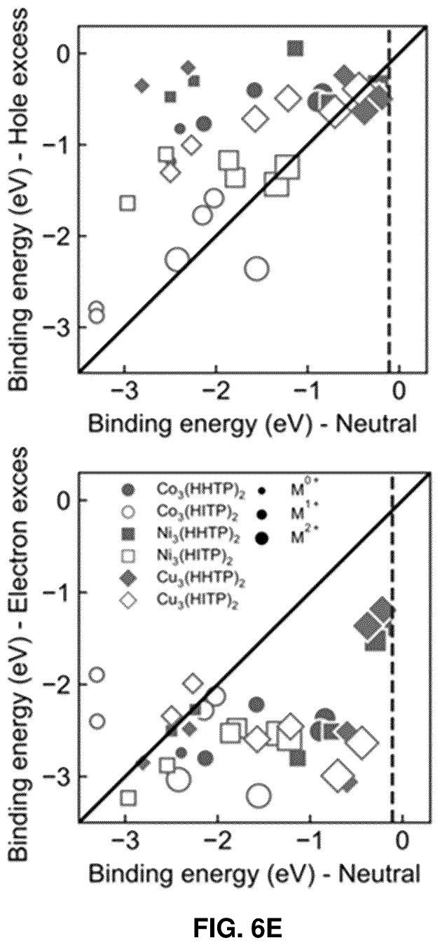

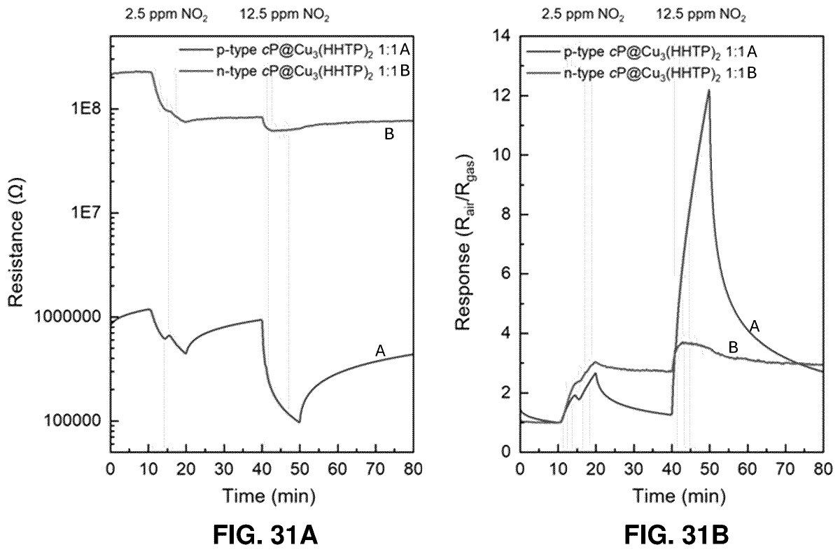

To verify the role of hole enrichment and test potential countereffect from electron enrichment, the cP component was substituted in the hybrid films with an n-type polymer (in this case, poly{[N,N′-bis(2-octyldodecyl)-naphthalene-1,4,5,8-bis(dicarboximide)-2,6-diyl]-alt-5,5′-(2,2′-bithiophene)}, also known as N2200) (FIG. 6A). Four types of sensors were then fabricated, i.e., p-type cP@Cu₃(HHTP)₂, p-type cP@Ni₃(HHTP)₂, n-type cP@Cu₃(HHTP)₂, and n-type cP@Ni₃(HHTP)₂ and their sensing behavior was compared under similar conditions. The channel resistance recovery was monitored after 3 cyclic exposures of the sensor to 2.5 ppm NO₂. P-type cP-based composites exhibited reversible sensing behaviors with minimal reduction in response, 9.1% and 11.5%, respectively, after the first cycle NO₂ exposure (FIGS. 6B-6C). Conversely, n-type cP-based composites demonstrated a dramatically diminished response after the first cycle. Furthermore, exposure to higher NO₂ concentrations in subsequent cycles showed no further change in the channel resistance for n-type composites (FIG. 31A-31B) indicative of a dosimetric sensing behavior. For instance, n-type cP@Cu₃(HHTP)₂ exhibited a higher response during the initial cycle, attributed to its abundant electron concentration facilitating electron donation to NO₂ and thus inducing greater response, but this enhanced response rapidly diminished by 78.3% during the second cycle, attributable to the incomplete recovery (or irreversible kinetics) (FIG. 6C). These results effectively emphasize the significance of hole enrichment in the hybrid films enabled by the polymeric component and its effect on the desorption of NO₂ gas, promoting favorable recovery kinetics.

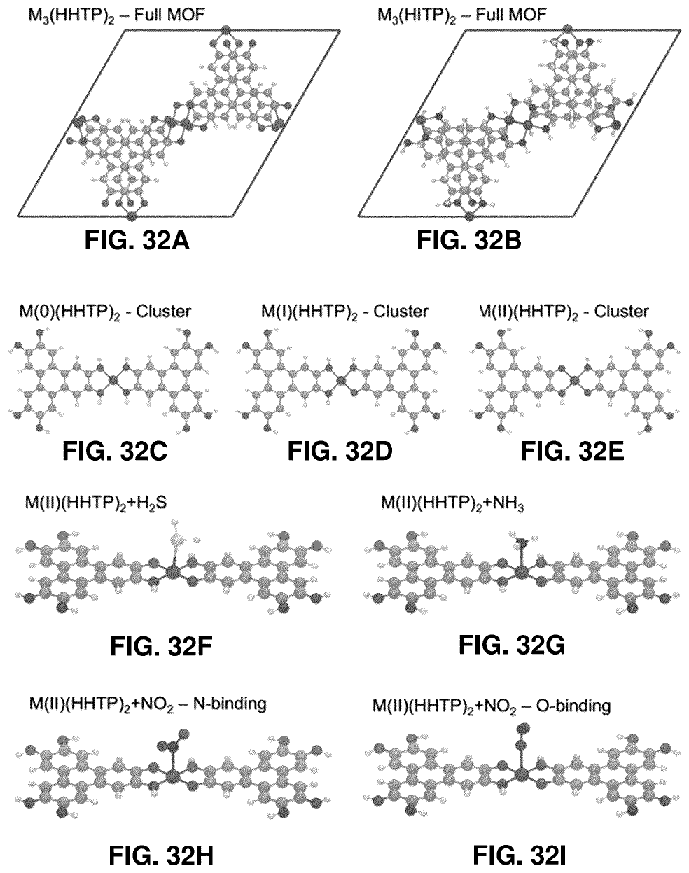

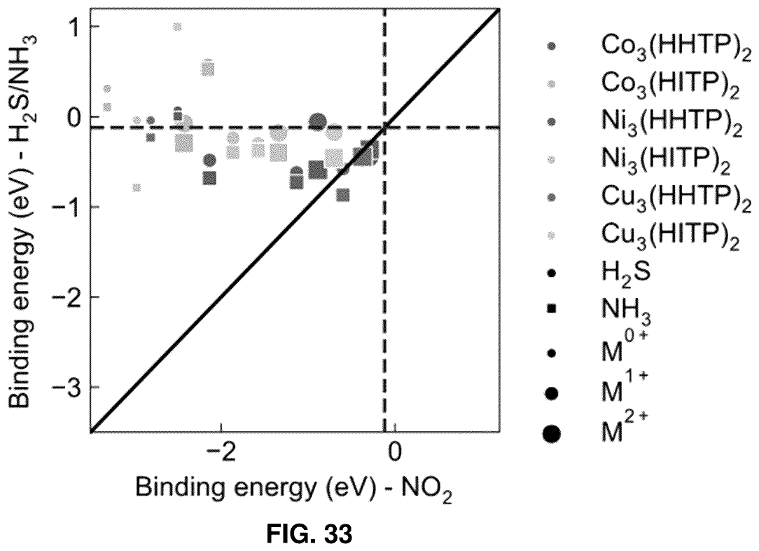

Using density functional theory (DFT) calculations, the binding energies were calculated between the gas molecules and the sensing material to gain further insight on the effect of cP hybridization on the observed sensing behavior. For the simulations, instead of modeling the entire cP@cMOFs systems, cP@cMOFs were represented with p/n-type cP as pure cMOFs with an additional injected hole/electron. By comparing the hybrid systems with the pure, charge-neutral cMOFs, this approach focused on the hole/electron enrichment effect of cPs on cMOFs. For all six cMOFs under consideration, the simulations considered three possible metal oxidation states, +0, +1, and +2 on the metal node (FIGS. 6D and 32A-32I). Across all cMOFs, it was observed that hole-enriched states exhibit lower binding energy than their neutral state and electron-rich states (FIG. 6E). These simulation results thus further supported the rationale of hole-enrichment as a major contributor to NO₂ desorption and thus sensing reversibility. Note that the case of Co-based cMOFs discussed above also show binding energies on par with other cMOFs, thus underscoring the importance of other contributors to the sensing kinetics such as film crystallinity and crystallite size (FIGS. 30C-30D). It was concluded that, in hole-excess scenarios, less electronic charge was transferred from the metal nodes to NO₂, thereby weakening their binding, compared to electron-excess systems (FIG. 6B). This charge transfer between the NO₂ and the metal nodes also supported superior selectivity over other gases, such as H₂S and NH₃, as evidenced by calculated selectivity data in FIGS. 28 and 33.

Therefore, a hybridization method was proposed that combines the properties of two types of mixed ionic-electronic conductors (MIECs), conductive polymers and MOFs (cP and cMOFs). The approach produced chemiresistors with better cycling stability and sustained dynamic range than those made solely from cMOFs or cPs. A detailed analysis was conducted to understand how hybridization with the conductive polymers enhanced the reversibility of cMOFs-based sensors, focusing on energy band alignments at the material interfaces and their impact on sensing thermodynamics and binding kinetics. Theoretical calculations further elucidated the effect of such hybridization of the interaction between cMOFs and the gaseous analyte. This approach suggests a versatile way towards designing conductive polymer/MOF composites with improved performance and processability. The hybridization paves the way for more tailored composite-based electronics leveraging the intrinsic properties of both polymers and MOFs.

Materials: Co(OAc)₂·4H₂O (Alfa Aesar), Co(NO₃)₂·6H₂O (Alfa Aesar), Cu(OAc)₂·xH₂O (Alfa Aesar), CuSO₄·5H₂O (Alfa Aesar), Ni(OAc)₂·4H₂O (Strem), and NaOAc (Alfa Aesar) were used without further purification. 2,3,6,7,10,11-hexaaminotriphenylene hexahydrochloride (HATP·6HCl) was prepared according to a procedure published elsewhere. 2,3,6,7,10,11-hexahydroxytriphenylene hydrate (HHTP, C₁₈H₁₂O₆·H₂O, 95%) was purchased from Tokyo Chemical Industry. For the synthesis of HHTP with higher crystallinity, recrystallization of HHTP ligand was conducted. N,N-dimethylformamide (DMF), acetone, and methanol were used as received without further purification.

cP@cMOF hybrid film processing: A polymer solution of 10 mg/ml in chloroform was prepared and stirred for 30 minutes at 35° C. The cMOFs were initially dispersed in deionized water and ethanol, for M₃(HITP)₂ series and M₃(HHTP)₂ series, respectively, immediately after synthesis and filtration. Subsequently, the dispersed cMOFs were sonicated for 5-30 minutes and blended with the polymer solution in appropriate w/w ratio to create the final solution for the hybrid film.

Powder X-ray diffraction (PXRD): PXRD analysis was conducted using a Bruker Advance II diffractometer equipped with a θ/2θ reflection geometry and Ni-filtered Cu Kα radiation (K_{α1}=1.5406 Å, K_{α2}=1.5444 Å, K_{α2}/K_{α1}=0.5). The tube voltage and current were set as 40 kV and 40 mA, respectively, during operation. Samples were prepared by placing the material on a zero-background silicon crystal plate.

Spectroscopy measurements: X-ray photoelectron spectroscopy (XPS) measurements were performed using a Physical Electronics PHI Versaprobe II X-ray photoelectron spectrometer equipped with an Al anode as a source. To prepare the samples for analysis, powders were compressed onto copper tapes to ensure complete coverage. The calibration of charge shift was performed by aligning the CIs peak of surface-adsorbed adventitious carbon to 284.8 eV. Ultraviolet-visible (UV-vis) absorption spectra were acquired using a Perkin Elmer 1050 UV-visible-NIR spectrophotometer. Raman spectra were collected on a Raman Reflex instrument utilizing a 532 nm laser source.

Chemiresistor fabrication and characterization: Gas sensing characterizations involved the coating of sensing materials onto prepatterned Al₂O₃-based sensor substrates. These substrates featured two parallel electrodes, each measuring 90 m in width and spaced 160 m apart. Following the preparation of the sensing material solutions at a concentration of 10 mg/ml, 5 l of the solution were cast onto the sensor substrate and dried. Measurement of the resistance of the sensing materials on the electrodes was carried out using a data acquisition system (Agilent 34972A) equipped with a 16-channel multiplexer (Agilent 34902A). To regulate the operating temperature, a microheater was positioned on the backside of the sensor substrate, which was controlled using a DC power supply (Agilent E3647A). For evaluation of sensing characteristics, the measured resistance values were converted into response values (Rₐᵢᵣ/R_{gas} or R_{gas}/Rₐᵢᵣ), where Rₐᵢᵣ and R_{gas} denoted the resistance in air and the gas, respectively. For stabilization of the baseline resistance, a baseline air was employed to stabilize the sensors for at least 2 hours. To establish concentration-dependent measurements, gas cylinders containing 50 ppm NO₂, 50 ppm H₂S, were purchased from Airgas. These gases were then diluted with air using mass flow controllers. Other organic analytes including ethanol, methanol, acetone, toluene, and xylene, were supplied to the sensing chamber using a FlexStream FlexBase module.

Experimental energy level measurement: The electronic band structures were constructed collectively by the following measurements: XPS with monochromatic Al Ka=1486.6 eV with −10 V bias was conducted to obtain both cut-off and fermi spectra. A gentle ion gun treatment (Monatomic source gun with 2000 eV, 30 seconds etch time) was performed to clean the surface. Tauc plots were converted from UV-vis spectra.

Theoretical calculation details: To enable facile control of the charge and oxidation state in the Density Functional Theory (DFT) studies, a finite cluster model of the cMOF system was studied using the hybrid B3LYP functional and the composite LACVP* basis set. These cluster models were extracted from DFT-optimized structures of the full periodic cMOFs with PBE-D2 and a plane wave basis set (kinetic energy cutoff of 400 eV).

Synthesis of Co₃(HHTP)₂: 20 mg of Co(OAc)₂·4H₂O was dispersed in 4 ml of water. Then, 16.2 mg of recrystallized HHTP ligand was dispersed in the mixture of 4 ml of water and 2 ml of DMF solvents. After mixing of the two solutions, sonication was conducted for 5 minutes. Then, the mixed solution was put into the sand heated at 85° C. for 24 hours (vial closed, without stirring). After reaction, the solution was filtered and washed with a large amount of water and acetone. Then, the obtained power was dried overnight. Note that for the synthesis of Co₃(HHTP)₂ with higher crystallinity, 16.2 mg of recrystallized HHTP ligand was dispersed in the mixture of 1.33 ml of water and 0.67 ml of DMF solvents. All the other synthetic procedures remain unchanged.

Synthesis of Cu₃(HHTP)₂: 24.9 mg of Cu(OAc)₂·H₂O was dispersed in 4 ml of water. 16.2 mg of recrystallized HHTP ligand was dispersed in 4 ml of DMF solvent. After mixing the solutions, sonication was conducted for 5 minutes. Then, the mixed solution was put into the sand heated at 85° C. for 24 hours (vial closed, without stirring). After reaction, the solution was filtered and washed with a large amount of water and acetone. Then, the obtained power was dried overnight. For the synthesis of Cu₃(HHTP)₂ with lower crystallinity, commercial HHTP ligand (without recrystallization process) was utilized with the same synthetic protocols.

Synthesis of Ni₃(HHTP)₂: 24.9 mg of Ni(OAc)₂·4H₂O was dispersed in 4 ml of water. 16.2 mg of recrystallized HHTP ligand was dispersed in 4 ml of water. After mixing the solutions, sonication was conducted for 5 minutes. Then, the mixed solution was put into the sand heated at 85° C. for 24 hours (vial closed, without stirring). After reaction, the solution was filtered and washed with a large amount of water and acetone. Then, the obtained power was dried overnight.

Synthesis of Co₃(HITP)₂: 8.13 mg of Co(NO₃)₂·6H₂O was dispersed in 3 ml of DMF. 10 mg of HATP·6HCl ligand was dispersed in 3 ml of water. After mixing the solutions, sonication was conducted for 5 minutes. Then, 4 ml of 2M NaOAc was added to the solution and the mixed solution was put into the sand heated at 65° C. for 2 hours (vial opened, with stirring). After reaction, the solution was filtered and washed with a large amount of water and methanol. Then, the obtained power was dried overnight.

Synthesis of Cu₃(HITP)₂: 7 mg of Cu(SO₄)₂·5H₂O was dispersed in 3 ml of DMF. 10 mg of HATP·6HCl ligand was dispersed in 3 ml of water. The mixed solution was sonicated for 5 minutes and put into the sand heated at 65° C. Then, 4 ml of 2M NaOAc was added to the solution and heated at 65° C. for 2 hours (vial opened, with stirring). After reaction, the solution was filtered and washed with a large amount of water and methanol. Then, the obtained power was dried overnight.

Synthesis of Ni₃(HITP)₂: 6.94 mg of Ni(OAc)₂·4H₂O was dispersed in 3 ml of DMF. 10 mg of HATP·6HCl ligand was dispersed in 3 ml of water. The mixed solution was sonicated for 5 minutes and put into the sand heated at 65° C. Then, 8 ml of 2M NaOAc was added to the solution and heated at 65° C. for 2 hours (vial opened, with stirring). After reaction, the solution was filtered and washed with a large amount of water and methanol. Then, the obtained power was dried overnight.

Synthesis of P-type cP: P-type cP selected for this study consists of ProDOT and BTD building units according to the previous reported procedure.

Synthesis of N-type cP: N-type cP selected for this study is N2200, or PNDI-2T, or poly{[N,N′-bis(2-octyldodecyl)-naphthalene-1,4,5,8-bis(dicarboximide)-2,6-diyl]-alt-5,5′-(2,2′-bithiophene) was synthesized using a Pd-catalyzed Stille coupling reaction. NDI-Br₂ (0.50 g, 0.46 mmol) and 5,5′-bis(trimethylstannyl)-2,2′-bithiophene (0.226 g, 0.46 mmol) were dissolved in dry chlorobenzene (7.5 mL). After degassing with N2 for 1 h, Pd₂(dba)₃ (8 mg) and P(o-Tol)₃ (11 mg) were added to the mixture and stirred for 48 h at 110° C. Subsequently, 2-bromothiophene and tributyl(thiophen-2-yl)stannane were injected to the reaction mixture for end-capping, and the reaction was stirred for 6 h. The polymer was precipitated in methanol, collected by filtration, and then purified by successive Soxhlet extraction with methanol, acetone, hexane, toluene, and chloroform. The final product was obtained by precipitation in methanol.

Density Functional Theory (DFT) Calculations Details: The starting structure was based on the experimentally determined lattice parameters of Cu₃(HHTP)₂. Each unit cell includes two layers, which were offset by a fractional coordinate of ( 1/32, 0, 0), (FIGS. 31A-31B). The atomic positions and lattice parameters were optimized using the Vienna Ab Initio Simulation Package (VASP) version 6.3.1, until the total energy converged to within 0.01 eV. The Perdew-Burke-Ernzerhof (PBE) functional was employed along with the plane-augmented wave (PAW) pseudopotential. A kinetic energy cutoff of 400 eV was used, and DFT-D2 corrections were applied to account for dispersion interactions. Given the large size of the unit cell, calculations were performed at the Γ point only. A background charge of +12 per unit cell was applied to the system. Additionally, each metal atom was assumed to have an oxidation state of +2 and to be in a high-spin state with ferromagnetic ordering.

DFT calculations for the cMOF cluster and the monomer of cP were performed using TeraChem. The B3LYP functional was used with the LACVP* basis set, which consists of 6-31G* for elements ranging from H to Ar, and employs the LANL2DZ effective core potential for heavier atoms. To obtain the cMOF cluster, one metal node and two linker molecules were extracted from the optimized full MOF structure. Subsequently, hydrogen atoms were added to the truncated bonds, and the positions of the hydrogen atoms were optimized. For calculating the binding energy of the gas molecules, the positions of the gas molecules were optimized while keeping the atomic positions of the cMOF cluster fixed. The L-BFGS algorithm was utilized for geometry optimizations via the translation-rotation-internal coordinate optimizer. Three different metal oxidation states were considered, +0, +1, and +2, each in high spin state. The oxidation state of the metal atom was adjusted by varying the number of hydrogen atoms on the metal-coordinating oxygen atoms, rather than by altering the system's total charge, to neutralize the metal node (FIGS. 32C-32E). This approach was taken because excess negative charge around the metal atom would ionize NO₂ to NO₂ and simply repel away the ion during the structure optimization. Overall charge neutrality was maintained, except for the hole-excess and electron-excess cMOF systems which were simulated by removing or adding one electron to the cMOF cluster, respectively. To model adsorption, it was assumed that H₂S and NH₃ adsorbed via the sulfur and nitrogen atoms, respectively, while both N-binding and O-binding were considered as possible adsorbate orientations for NO₂ (FIGS. 32F-32I). Likewise, the structure of the cP monomer was optimized, and the binding energies of the gas molecules were determined by optimizing their positions while fixing the atomic coordinates of the monomer. A negative binding energy indicates favorable binding.

H₂S, NH₃, and NO₂ selectivity: The binding energies of H₂S, NH₃, and NO₂ were compared to investigate the source of NO₂ selectivity. Across all MOFs of all oxidation states, NO₂ generally exhibits stronger binding than H₂S or NH₃ (FIG. 32A-32I). Out of 36 total cases, only five exceptions to this trend were observed, specifically in cases involving Ni₃(HHTP)₂ and Cu₃(HHTP)₂. Furthermore, the binding energy of NO₂, considering both N-binding and O-binding, ranges from −3.3 to −0.2 eV, whereas the binding energies of H₂S and NH₃ never exceed −1.0 eV. The notable disparity in the range of binding energies suggests that the primary interaction between the metal node and H₂S or NH₃ is largely governed by van der Waals interactions, unlike NO₂ binding which is enhanced by chemisorption.

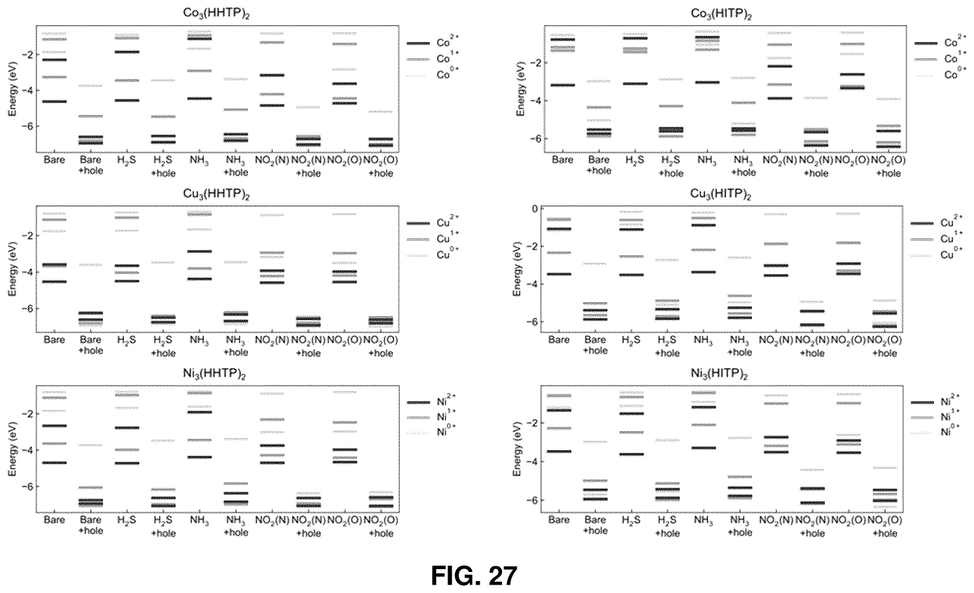

Gas molecule adsorption on cP: The binding energies of gas molecules were assessed with the cP to determine whether the primary adsorption site is the cP or cMOF. ProDOT connected to BTD as a monomer was modeled and eight potential adsorption sites that were neither carbon nor hydrogen atoms were considered. The binding energies of all three gas molecules fell within a range of −0.20 to −0.05 eV, suggesting that the interactions between the cP and the gas molecules are primarily weak van der Waals interactions (FIG. 27). The gas molecules exhibited stronger binding with the cMOF than with the cP, indicating that the primary adsorption site is likely the metal node of the cMOF.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition, comprising:
an electronically conductive polymer; and
a plurality of particles homogenously distributed throughout a bulk of the electronically conductive polymer, the plurality of particles comprising a conjugated metal-organic framework (MOF),
wherein the electronically conductive polymer has the formula [A-B]ₙ, wherein A is an electron acceptor monomeric unit, B is an electron donor monomeric unit, and n is greater than or equal to 2.

2. The composition of claim 1, wherein the electron acceptor monomeric unit is selected from the group consisting of: 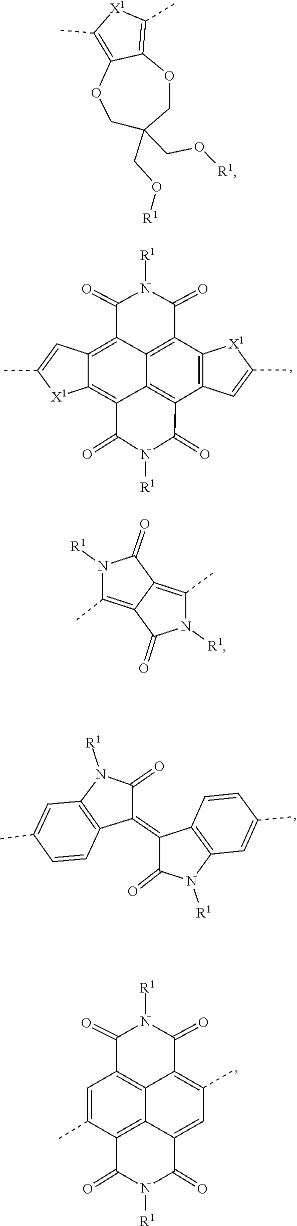
and optionally substituted derivatives thereof,
wherein:
each X¹ group is the same or different and is selected from the group consisting of O, S, Se, Te, and NR¹,
each R¹ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
each dotted line represents: (i) a terminal end of the electronically conductive polymer; or (ii) a bond between the electron acceptor monomeric unit and the electron donor monomeric unit.

3. The composition of claim 2, wherein the electron donor monomeric unit is selected from the group consisting of: 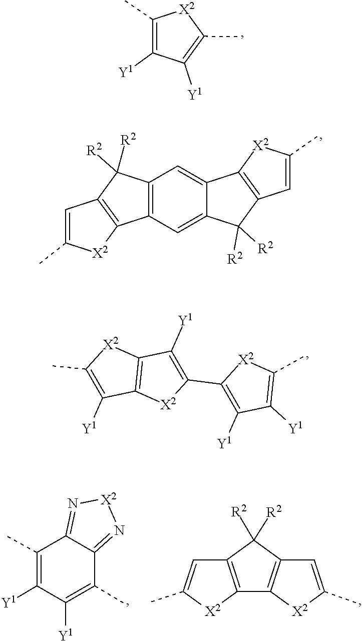
and optionally substituted derivatives thereof,
wherein:
each X² group is the same or different and is selected from the group consisting of O, S, Se, Te, and NR²,
each Y¹ group is the same or different and is selected from the group consisting of H, C₁-C₁₀ alkyl, C₂-C₁₀ alkenyl, C₃-C₁₀ alkynyl, and a halogen,
each R² group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
each dotted line represents: (i) the terminal end of the electronically conductive polymer; or (ii) the bond between the electron acceptor monomeric unit and the electron donor monomeric unit.

4. The composition of claim 1, wherein the electronically conductive polymer is a p-type electronically conductive polymer.

5. The composition of claim 1, wherein the conjugated MOF comprises a plurality of metals ions.

6. The composition of claim 5, wherein the plurality of metal ions comprises transition metal ions.

7. The composition of claim 5, wherein the plurality of metal ions comprises copper ions, nickel ions, cobalt ions, iron ions, zinc ions, palladium ions, and/or combinations thereof.

8. The composition of claim 5, wherein at least one metal ion of the plurality of metals ions is coordinated to at least one conjugated ligand.

9. The composition of claim 8, wherein the at least one conjugated ligand is selected from the group consisting of: 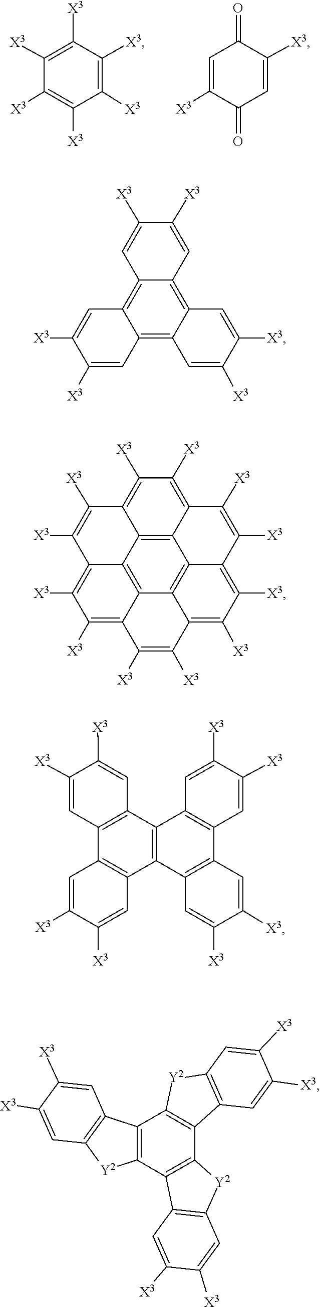 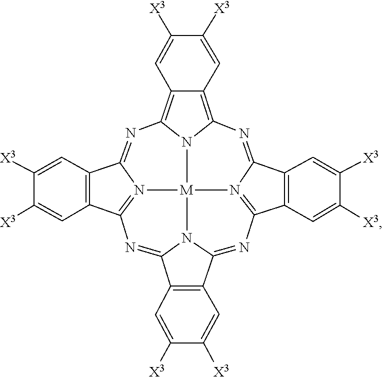
optionally substituted derivatives thereof,
wherein:
each X³ group is the same or different and is selected from the group consisting of O, S, Se, Te, and NR³,
each Y² group is the same or different and is selected from the group consisting of C, NR³, O, S, Se, and Te,
each R³ group is the same or different and is selected from the group consisting of H, C₁-C₁₀ alkyl, C₂-C₁₀ alkenyl, C₃-C₁₀ alkynyl, ethers thereof, halogenated derivatives thereof, and optionally substituted derivatives thereof, and
M is a metal ion.

10. The composition of claim 9, wherein M comprises copper ions, nickel ions, cobalt ions, iron ions, zinc ions, palladium ions, and/or combinations thereof.

11. The composition of claim 9, wherein the at least one metal ion of the plurality of metal ions is coordinated to the at least one conjugated ligand via at least one X³ group.

12. The composition of claim 1, wherein the conjugated MOF comprises a plurality of pores, each pore of the plurality of pores having a maximum characteristic dimension of at least 1 nm.

13. The composition of claim 1, wherein the composition comprises the plurality of particles in an amount greater than or equal to 5 weight percent (wt %) and less than or equal to 75 wt % versus a total weight of the composition.

14. The composition of claim 1, wherein the composition comprises the plurality of particles in an amount greater than or equal to 5 wt % and less than or equal to 50 wt % versus a total weight of the composition.

15. A sensor, comprising:
a first electrode;
a second electrode; and
a composite region comprising: (i) an electronically conductive polymer; and (ii) an electronically conductive metal-organic framework (MOF),
wherein the composite region is configured to adsorb an analyte at a temperature greater than or equal to 10° C. and less than or equal to 30° C., and wherein adsorption of the analyte within the composite region causes a detectable change in an electronic characteristic of the sensor.

16. The sensor of claim 15, wherein the first electrode, the second electrode, and the composite region are disposed on a substrate.

17. The sensor of claim 15, wherein the electronically conductive polymer comprises a conjugated system.

18. The sensor of claim 15, wherein the electronically conductive MOF is conjugated.

19. The sensor of claim 15, wherein the composite region is configured to desorb the analyte at the temperature greater than or equal to 10° C. and less than or equal to 30° C.

20. The sensor of claim 19, wherein the composite region is configured to adsorb the analyte and desorb the analyte at least 50 times.

21. The sensor of claim 19, wherein the composite region is configured to adsorb the analyte and desorb the analyte at least 90 times.

22. The sensor of claim 19, wherein the composite region is configured adsorb the analyte and desorb the analyte at least 95 times.

23. The sensor of claim 15, wherein the composite region is configured to adsorb the analyte and desorb the analyte at least 100 times.

24. The sensor of claim 15, wherein the detectable change in the electronic characteristic of the sensor is a change in resistance of the sensor.

25-36. (canceled)
